(19) United States
(12) Patent Application Publication
(10) Pub. No.: US 2026/0292764 A1
(43) Pub. Date: Sep. 24, 2026

(54) SIDELINK RECEIVE-TRANSMIT TIME DIFFERENCE MEASUREMENT TYPES

(71) Applicant: QUALCOMM Incorporated, San Diego, CA (US)

(72) Inventors: Alexandros MANOLAKOS, Athens (GR); Gabi SARKIS, San Diego, CA (US)

(21) Appl. No.: 19/472,028

(22) PCT Filed: Apr. 11, 2024
(86) PCT No.: PCT/US2024/024126

§ 371 Date: Oct. 2, 2025

(30) Foreign Application Priority Data
May 2, 2023 (GR) 20230100359

(51) Int. Cl. H04W 64/00; H04W 24/08; H04W 92/18

(52) U.S. Cl. CPC H04W 64/00; H04W 24/08; H04W 92/18

(57) ABSTRACT

In an aspect, a user equipment (UE) transmits a capability indication that indicates that the UE is capable of performing a first sidelink (SL) receive-transmit (Rx-Tx) time difference measurement type and a second SL Rx-Tx time difference measurement type to a position estimation entity (PDE). The PDE transmits a measurement request for the UE to perform one or more SL Rx-Tx time difference measurements. The UE determines the SL Rx-Tx time difference measurement type to use based on an explicit network designated SL Rx-Tx time difference measurement type or an autonomous selection at the UE. The UE transmits a measurement report to the PDE, which receives the measurement report and is able to determine the SL Rx-Tx time difference measurement type used by the UE.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data. Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of operating a user equipment (UE) includes transmitting a capability indication that indicates that the UE is capable of performing a first sidelink (SL) receive-transmit (Rx-Tx) time difference measurement type and a second SL Rx-Tx time difference measurement type to a position estimation entity, wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe; receiving a measurement request for the UE to perform one or more SL Rx-Tx time difference measurements; and determining whether to perform the one or more SL Rx-Tx time difference measurements in accordance with the first SL Rx-Tx time difference measurement type or the second SL Rx-Tx time difference measurement type, wherein the determination is based on an explicit network-designated SL Rx-Tx time difference measurement type associated with the measurement request, or wherein the determination comprises an autonomous selection at the UE based on one or more rules associated with one or more criteria; performing the one or more SL Rx-Tx time difference measurements in accordance with the determined SL Rx-Tx time difference measurement type; and transmitting a measurement report comprising measurement information that is based on the one or more SL Rx-Tx time difference measurements to a position estimation entity.

In an aspect, a method of operating a position estimation entity includes receiving a capability indication that indicates that a user equipment (UE) is capable of performing a first sidelink (SL) receive-transmit (Rx-Tx) time difference measurement type and a second SL Rx-Tx time difference measurement type to a position estimation entity, wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe; transmitting a measurement request for the UE to perform one or more SL Rx-Tx time difference measurements; receiving a measurement report comprising measurement information that is based on one or more SL Rx-Tx time difference measurements; and determining whether the measurement information is based on the first SL Rx-Tx time difference measurement type or the second SL Rx-Tx time difference measurement type.

In an aspect, a user equipment (UE) includes a memory; and at least one processor communicatively coupled to the memory, the at least one processor configured to: transmit a capability indication that indicates that the UE is capable of performing a first sidelink (SL) receive-transmit (Rx-Tx) time difference measurement type and a second SL Rx-Tx time difference measurement type to a position estimation entity, wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe; receive a measurement request for the UE to perform one or more SL Rx-Tx time difference measurements; and determine whether to perform the one or more SL Rx-Tx time difference measurements in accordance with the first SL Rx-Tx time difference measurement type or the second SL Rx-Tx time difference measurement type, wherein the determination is based on an explicit network-designated SL Rx-Tx time difference measurement type associated with the measurement request, or wherein the determination comprises an autonomous selection at the UE based on one or more rules associated with one or more criteria; perform the one or more SL Rx-Tx time difference measurements in accordance with the determined SL Rx-Tx time difference measurement type; and transmit a measurement report comprising measurement information that is based on the one or more SL Rx-Tx time difference measurements to a position estimation entity.

In an aspect, a position estimation entity includes a memory; and at least one processor communicatively coupled to the memory, the at least one processor configured to: receive a capability indication that indicates that a user equipment (UE) is capable of performing a first sidelink (SL) receive-transmit (Rx-Tx) time difference measurement type and a second SL Rx-Tx time difference measurement type to a position estimation entity, wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe; transmit a measurement request for the UE to perform one or more SL Rx-Tx time difference measurements; receive a measurement report comprising measurement information that is based on one or more SL Rx-Tx time difference measurements; and determine whether the measurement information is based on the first SL Rx-Tx time difference measurement type or the second SL Rx-Tx time difference measurement type.

In an aspect, a user equipment (UE) includes means for transmitting a capability indication that indicates that the UE is capable of performing a first sidelink (SL) receive-transmit (Rx-Tx) time difference measurement type and a second SL Rx-Tx time difference measurement type to a position estimation entity, wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe; means for receiving a measurement request for the UE to perform one or more SL Rx-Tx time difference measurements; and means for determining whether to perform the one or more SL Rx-Tx time difference measurements in accordance with the first SL Rx-Tx time difference measurement type or the second SL Rx-Tx time difference measurement type, wherein the determination is based on an explicit network-designated SL Rx-Tx time difference measurement type associated with the measurement request, or wherein the determination comprises an autonomous selection at the UE based on one or more rules associated with one or more criteria; means for performing the one or more SL Rx-Tx time difference measurements in accordance with the determined SL Rx-Tx time difference measurement type; and means for transmitting a measurement report comprising measurement information that is based on the one or more SL Rx-Tx time difference measurements to a position estimation entity.

In an aspect, a position estimation entity includes means for receiving a capability indication that indicates that a user equipment (UE) is capable of performing a first sidelink (SL) receive-transmit (Rx-Tx) time difference measurement type and a second SL Rx-Tx time difference measurement type to a position estimation entity, wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe; means for transmitting a measurement request for the UE to perform one or more SL Rx-Tx time difference measurements; means for receiving a measurement report comprising measurement information that is based on one or more SL Rx-Tx time difference measurements; and means for determining whether the measurement information is based on the first SL Rx-Tx time difference measurement type or the second SL Rx-Tx time difference measurement type.

In an aspect, a non-transitory computer-readable medium storing computer-executable instructions that, when executed by a user equipment (UE), cause the UE to: transmit a capability indication that indicates that the UE is capable of performing a first sidelink (SL) receive-transmit (Rx-Tx) time difference measurement type and a second SL Rx-Tx time difference measurement type to a position estimation entity, wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe; receive a measurement request for the UE to perform one or more SL Rx-Tx time difference measurements; and determine whether to perform the one or more SL Rx-Tx time difference measurements in accordance with the first SL Rx-Tx time difference measurement type or the second SL Rx-Tx time difference measurement type, wherein the determination is based on an explicit network-designated SL Rx-Tx time difference measurement type associated with the measurement request, or wherein the determination comprises an autonomous selection at the UE based on one or more rules associated with one or more criteria; perform the one or more SL Rx-Tx time difference measurements in accordance with the determined SL Rx-Tx time difference measurement type; and transmit a measurement report comprising measurement information that is based on the one or more SL Rx-Tx time difference measurements to a position estimation entity.

In an aspect, a non-transitory computer-readable medium storing computer-executable instructions that, when executed by a position estimation entity, cause the position estimation entity to: receive a capability indication that indicates that a user equipment (UE) is capable of performing a first sidelink (SL) receive-transmit (Rx-Tx) time difference measurement type and a second SL Rx-Tx time difference measurement type to a position estimation entity, wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe: transmit a measurement request for the UE to perform one or more SL Rx-Tx time difference measurements; receive a measurement report comprising measurement information that is based on one or more SL Rx-Tx time difference measurements; and determine whether the measurement information is based on the first SL Rx-Tx time difference measurement type or the second SL Rx-Tx time difference measurement type.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 is a diagram illustrating various downlink channels within an example downlink slot, according to aspects of the disclosure.

FIG. 6 is a diagram illustrating various uplink channels within an example uplink slot, according to aspects of the disclosure.

FIG. 7 illustrates examples of various positioning methods supported in New Radio (NR), according to aspects of the disclosure.

FIG. 8 is a diagram illustrating an example round-trip-time (RTT) procedure for determining a location of a UE, according to aspects of the disclosure.

FIG. 9 is a diagram showing example timings of RTT measurement signals exchanged between a base station and a UE, according to aspects of the disclosure.

FIGS. 10A and 10B illustrate various scenarios of interest for sidelink-only or joint Uu and sidelink positioning, according to aspects of the disclosure.

FIGS. 11A and 11B are diagrams of example sidelink slot structures with and without feedback resources, according to aspects of the disclosure.

FIG. 12 is a diagram illustrating an example of a resource pool for positioning configured within a sidelink resource pool for communication, according to aspects of the disclosure.

FIG. 13 illustrates an exemplary process of communications according to an aspect of the disclosure.

FIG. 14 illustrates an exemplary process of communications according to an aspect of the disclosure.

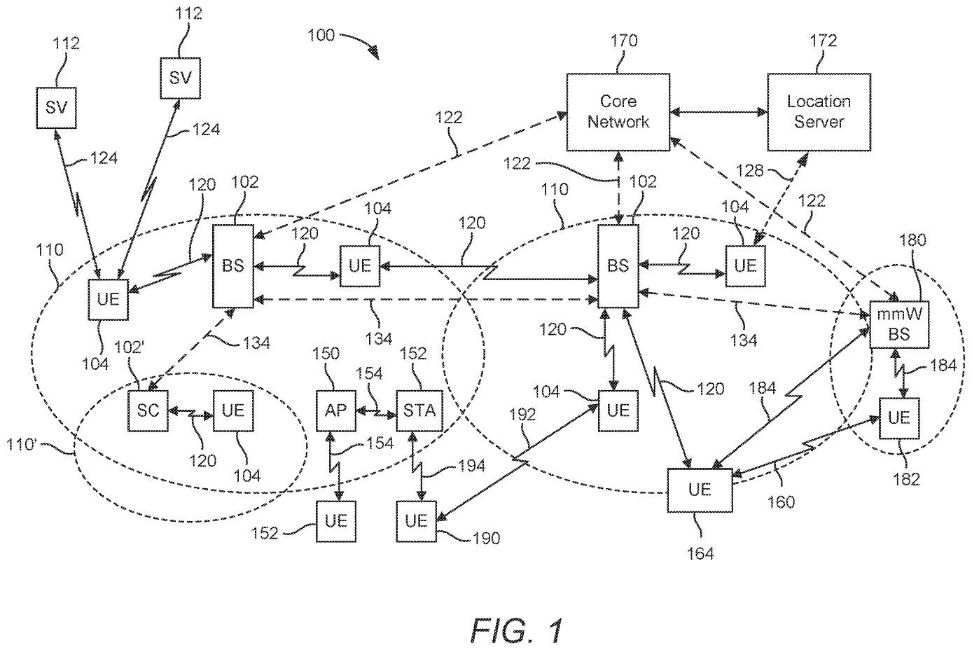

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to sidelink (SL) receive-transmit (Rx-Tx) SL Rx-Tx Time Difference capability (to a position estimation entity, such as an LMF (e.g., for network-assisted position estimation) or the UE or another UE (e.g., for UE-based position estimation).

Particular aspects of the subject matter described in this disclosure can be implemented to realize one or more of the following potential advantages. Aspects of the disclosure are directed to determination of a SL Rx-Tx time difference measurement type (e.g., Option 1 or Option 2) of in a scenario where a UE supports both Options 1-2 (or Option 3). In some aspects, the determination of the SL Rx-Tx time difference measurement type may be based on an explicit network-designated SL Rx-Tx time difference measurement type associated with the measurement request, or an autonomous selection at the UE based on one or more rules associated with one or more criteria. Such aspects may provide various technical advantages, such as more flexibility in terms of SL Rx-Tx time difference measurement reporting for SL-based position estimation of the UE. For example, one SL Rx-Tx time difference measurement type may in certain scenarios be more appropriate than the other SL Rx-Tx time difference measurement type (e.g., based on criteria such as UE mobility, inter-subframe time difference, RSRP change, etc.), and selecting the more appropriate SL Rx-Tx time difference measurement type may result in less positioning latency, more positioning accuracy, less power consumption at the UE, and so on.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal.” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station.

Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

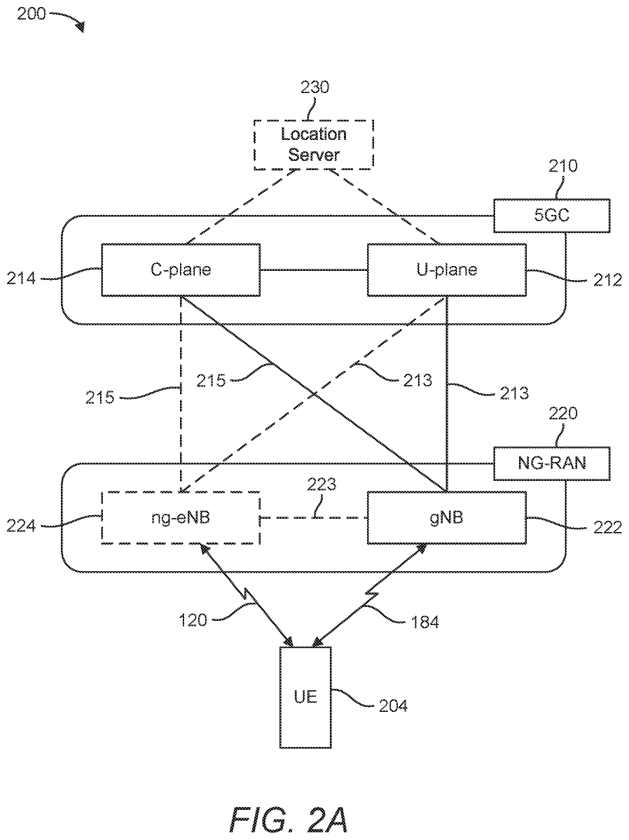

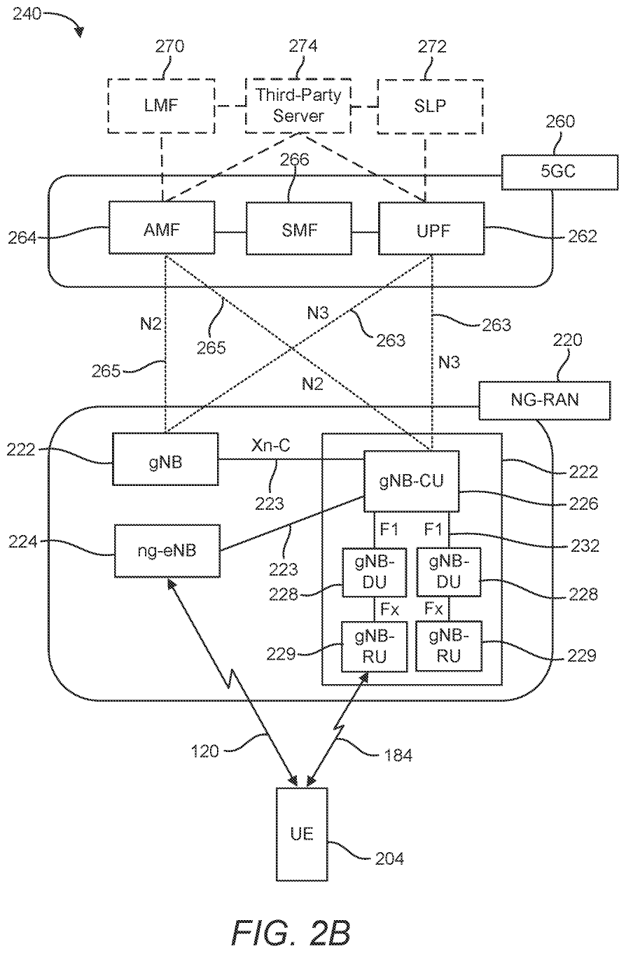

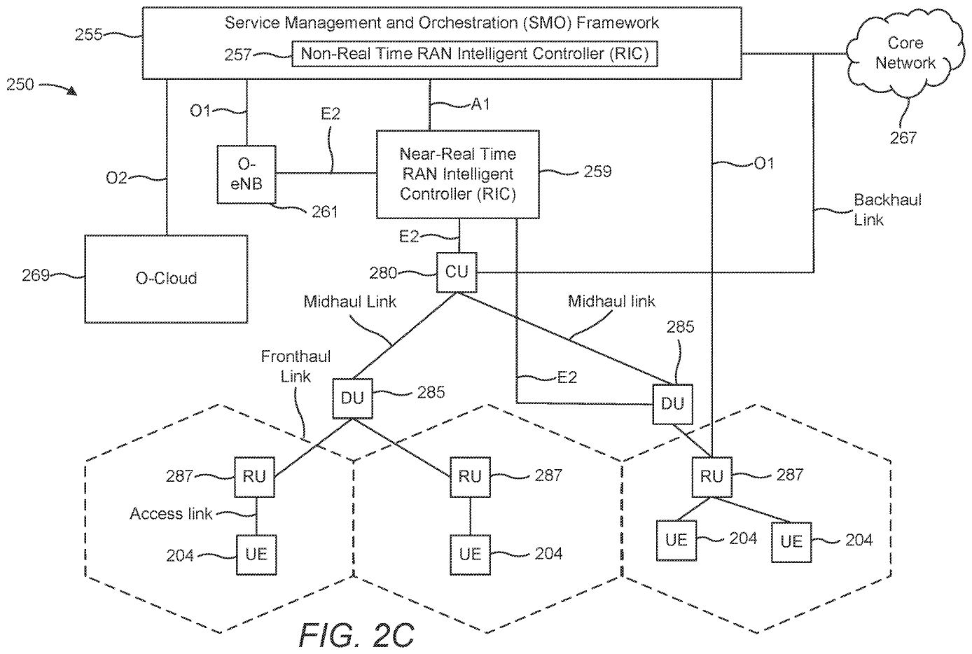

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks. IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP) (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface.

The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC. SDAP, and PDCP layers, with a gNB-DU 228 via the RLC and MAC lavers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUs 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

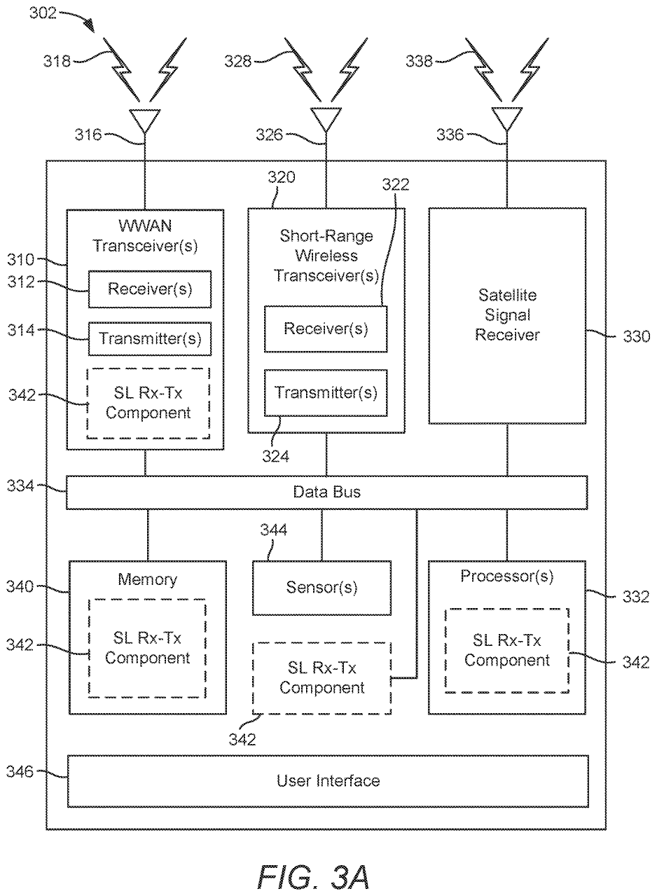

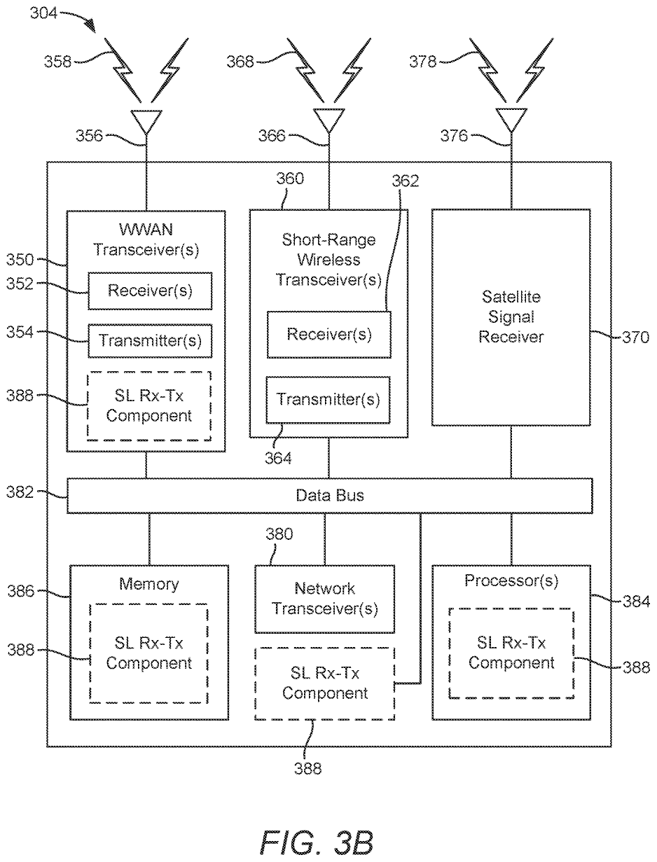

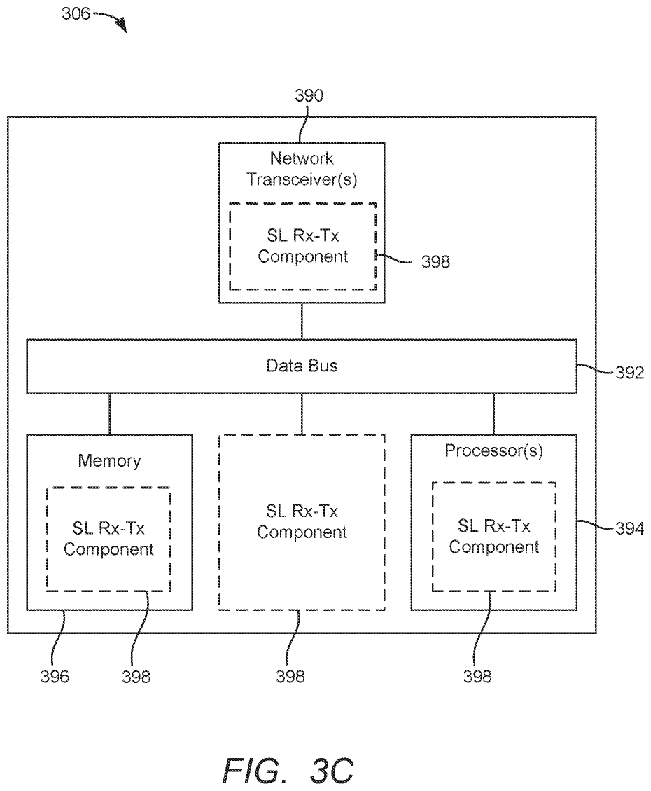

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH-K transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively.

Where the satellite signal receivers 330 and 370 are satellite positioning system receivers, the satellite positioning/communication signals 338 and 378 may be global positioning system (GPS) signals, global navigation satellite system (GLONASS®) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include SL Rx-Tx Component 342, 388, and 398, respectively. The SL Rx-Tx Component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the SL Rx-Tx Component 342, 388, and 398 may be external to the processors 332, 384, and 394 (e.g., part of a modem processing system, integrated with another processing system, etc.). Alternatively, the SL Rx-Tx Component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the SL Rx-Tx Component 342, which may be, for example, part of the one or more WWAN transceivers 310, the memory 340, the one or more processors 332, or any combination thereof, or may be a standalone component. FIG. 3B illustrates possible locations of the SL Rx-Tx Component 388, which may be, for example, part of the one or more WWAN transceivers 350, the memory 386, the one or more processors 384, or any combination thereof, or may be a standalone component. FIG. 3C illustrates possible locations of the SL Rx-Tx Component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment. RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer−1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK). M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer−1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the downlink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the SL Rx-Tx Component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

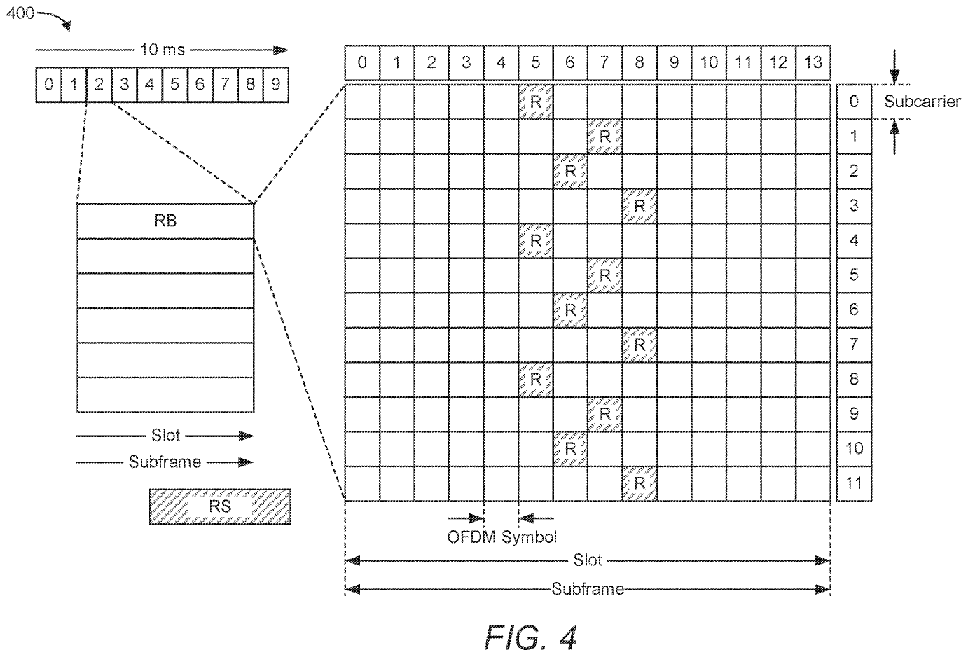

Various frame structures may be used to support downlink and uplink transmissions between network nodes (e.g., base stations and UEs). FIG. 4 is a diagram 400 illustrating an example frame structure, according to aspects of the disclosure. The frame structure may be a downlink or uplink frame structure. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1, 25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

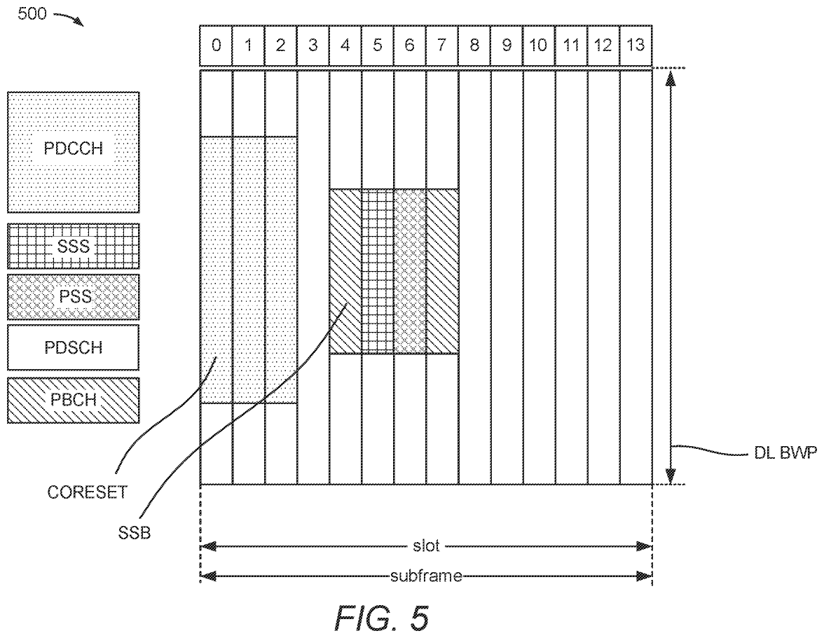

FIG. 5 is a diagram 500 illustrating various downlink channels within an example downlink slot. In FIG. 5, time is represented horizontally (on the X axis) with time increasing from left to right, while frequency is represented vertically (on the Y axis) with frequency increasing (or decreasing) from bottom to top. In the example of FIG. 5, a numerology of 15 kHz is used. Thus, in the time domain, the illustrated slot is one millisecond (ms) in length, divided into 14 symbols.

In NR, the channel bandwidth, or system bandwidth, is divided into multiple bandwidth parts (BWPs). A BWP is a contiguous set of RBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 5, a primary synchronization signal (PSS) is used by a UE to determine subframe/symbol timing and a physical laver identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries a master information block (MIB), may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 5, there is one CORESET per BWP, and the CORESET spans three symbols (although it may be only one or two symbols) in the time domain. Unlike LTE control channels, which occupy the entire system bandwidth, in NR, PDCCH channels are localized to a specific region in the frequency domain (i.e., a CORESET).

Thus, the frequency component of the PDCCH shown in FIG. 5 is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE, referred to as uplink and downlink grants, respectively. More specifically, the DI indicates the resources scheduled for the downlink data channel (e.g., PDSCH) and the uplink data channel (e.g., physical uplink shared channel (PUSCH)). Multiple (e.g., up to eight) DCIs can be configured in the PDCCH, and these DCIs can have one of multiple formats. For example, there are different DCI formats for uplink scheduling, for downlink scheduling, for uplink transmit power control (TPC), etc. A PDCCH may be transported by 1, 2, 4, 8, or 16 CCEs in order to accommodate different DCI payload sizes or coding rates.

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration.

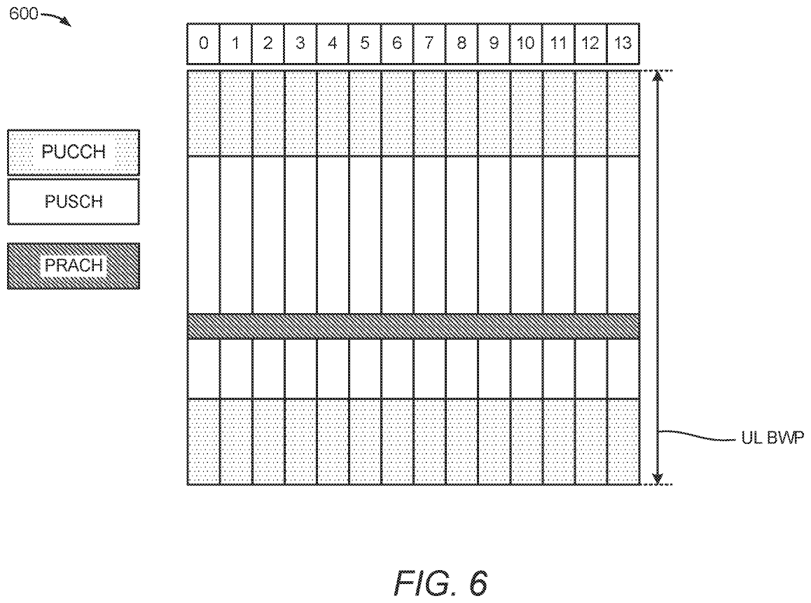

Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 6 illustrates an example PRS resource configuration for comb-4 (which spans four symbols). That is, the locations of the shaded REs (labeled “R”) indicate a comb-4 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource.

The following are the frequency offsets from symbol to symbol for comb sizes 2, 4, 6, and 12 over 2, 4, 6, and 12 symbols, 2-symbol comb-2: {0, 1}; 4-symbol comb-2: {0, 1, 0, 1}: 6-symbol comb-2: {0, 1, 0, 1, 0, 1}: 12-symbol comb-2: {0, 1, 0, 1, 0, 1, 0, 1, 0, 1, 0, 1}; 4-symbol comb-4: {0, 2, 1, 3}(as in the example of FIG. 6); 12-symbol comb-4: {0, 2, 1, 3, 0, 2, 1, 3, 0, 2, 1, 3}; 6-symbol comb-6: {0, 3, 1, 4, 2, 5}: 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance, a “positioning occasion.” “a positioning instance,” a “positioning repetition,” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR. TRS, PTRS, CRS, CSI-RS. DMRS, PSS, SSS, SSB, SRS, UL-PRS, etc.

In addition, the terms “positioning reference signal” and “PRS” may refer to downlink, uplink, or sidelink positioning reference signals, unless otherwise indicated by the context. If needed to further distinguish the type of PRS, a downlink positioning reference signal may be referred to as a “DL-PRS,” an uplink positioning reference signal (e.g., an SRS-for-positioning, PTRS) may be referred to as an “UL-PRS.” and a sidelink positioning reference signal may be referred to as an “SL-PRS.” In addition, for signals that may be transmitted in the downlink, uplink, and/or sidelink (e.g., DMRS), the signals may be prepended with “DL,” “UL,” or “SL” to distinguish the direction. For example, “UL-DMRS” is different from “DL-DMRS.”

FIG. 6 is a diagram 600 illustrating various uplink channels within an example uplink slot. In FIG. 6, time is represented horizontally (on the X axis) with time increasing from left to right, while frequency is represented vertically (on the Y axis) with frequency increasing (or decreasing) from bottom to top. In the example of FIG. 6, a numerology of 15 kHz is used. Thus, in the time domain, the illustrated slot is one millisecond (ms) in length, divided into 14 symbols.

A random-access channel (RACH), also referred to as a physical random-access channel (PRACH), may be within one or more slots within a frame based on the PRACH configuration. The PRACH may include six consecutive RB pairs within a slot. The PRACH allows the UE to perform initial system access and achieve uplink synchronization. A physical uplink control channel (PUCCH) may be located on edges of the uplink system bandwidth. The PUCCH carries uplink control information (UCI), such as scheduling requests, CSI reports, a channel quality indicator (CQI), a precoding matrix indicator (PMI), a rank indicator (RI), and HARQ ACK/NACK feedback. The physical uplink shared channel (PUSCH) carries data, and may additionally be used to carry a buffer status report (BSR), a power headroom report (PHR), and/or UCI.

In an aspect, the reference signal carried on the REs labeled “R” in FIG. 4 may be SRS. SRS transmitted by a UE may be used by a base station to obtain the channel state information (CSI) for the transmitting UE. CSI describes how an RF signal propagates from the UE to the base station and represents the combined effect of scattering, fading, and power decay with distance. The system uses the SRS for resource scheduling, link adaptation, massive MIMO, beam management, etc.

A collection of REs that are used for transmission of SRS is referred to as an “SRS resource,” and may be identified by the parameter “SRS-ResourceId.” The collection of resource elements can span multiple PRBs in the frequency domain and ‘N’ (e.g., one or more) consecutive symbol(s) within a slot in the time domain. In a given OFDM symbol, an SRS resource occupies one or more consecutive PRBs. An “SRS resource set” is a set of SRS resources used for the transmission of SRS signals, and is identified by an SRS resource set ID (“SRS-ResourceSetId”).

The transmission of SRS resources within a given PRB has a particular comb size (also referred to as the “comb density”). A comb size ‘N’ represents the subcarrier spacing (or frequency/tone spacing) within each symbol of an SRS resource configuration.

Specifically, for a comb size ‘N,’ SRS are transmitted in every Nth subcarrier of a symbol of a PRB. For example, for comb-4, for each symbol of the SRS resource configuration, REs corresponding to every fourth subcarrier (such as subcarriers 0, 4, 8) are used to transmit SRS of the SRS resource. In the example of FIG. 4, the illustrated SRS is comb-4 over four symbols. That is, the locations of the shaded SRS REs indicate a comb-4 SRS resource configuration.

Currently, an SRS resource may span 1, 2, 4, 8, or 12 consecutive symbols within a slot with a comb size of comb-2, comb-4, or comb-8. The following are the frequency offsets from symbol to symbol for the SRS comb patterns that are currently supported, 1-symbol comb-2: {0}; 2-symbol comb-2: {0, 1}; 2-symbol comb-4: {0, 2}, 4-symbol comb-2: {0, 1, 0, 1}; 4-symbol comb-4: {0, 2, 1, 3}(as in the example of FIG. 4); 8-symbol comb-4: {0, 2, 1, 3, 0, 2, 1, 3}; 12-symbol comb-4: {0, 2, 1, 3, 0, 2, 1, 3, 0, 2, 1, 3}; 4-symbol comb-8: {0, 4, 2, 6}; 8-symbol comb-8: {0, 4, 2, 6, 1, 5, 3, 7}; and 12-symbol comb-8: {0, 4, 2, 6, 1, 5, 3, 7, 0, 4, 2, 6}.

Generally, as noted above, a UE transmits SRS to enable the receiving base station (either the serving base station or a neighboring base station) to measure the channel quality (i.e., CSI) between the UE and the base station. However, SRS can also be specifically configured as uplink positioning reference signals for uplink-based positioning procedures, such as uplink time difference of arrival (UL-TDOA), round-trip-time (RTT), uplink angle-of-arrival (UL-AoA), etc. As used herein, the term “SRS” may refer to SRS configured for channel quality measurements or SRS configured for positioning purposes. The former may be referred to herein as “SRS-for-communication” and/or the latter may be referred to as “SRS-for-positioning” or “positioning SRS” when needed to distinguish the two types of SRS.

Several enhancements over the previous definition of SRS have been proposed for SRS-for-positioning (also referred to as “UL-PRS”), such as a new staggered pattern within an SRS resource (except for single-symbol/comb-2), a new comb type for SRS, new sequences for SRS, a higher number of SRS resource sets per component carrier, and a higher number of SRS resources per component carrier. In addition, the parameters “SpatialRelationInfo” and “PathLossReference” are to be configured based on a downlink reference signal or SSB from a neighboring TRP. Further still, one SRS resource may be transmitted outside the active BWP, and one SRS resource may span across multiple component carriers. Also, SRS may be configured in RRC connected state and only transmitted within an active BWP. Further, there may be no frequency hopping, no repetition factor, a single antenna port, and new lengths for SRS (e.g., 8 and 12 symbols). There also may be open-loop power control and not closed-loop power control, and comb-8 (i.e., an SRS transmitted every eighth subcarrier in the same symbol) may be used. Lastly, the UE may transmit through the same transmit beam from multiple SRS resources for UL-AoA. All of these are features that are additional to the current SRS framework, which is configured through RRC higher layer signaling (and potentially triggered or activated through a MAC control element (MAC-CE) or downlink control information (DCI)).

NR supports a number of cellular network-based positioning technologies, including downlink-based, uplink-based, and downlink-and-uplink-based positioning methods.

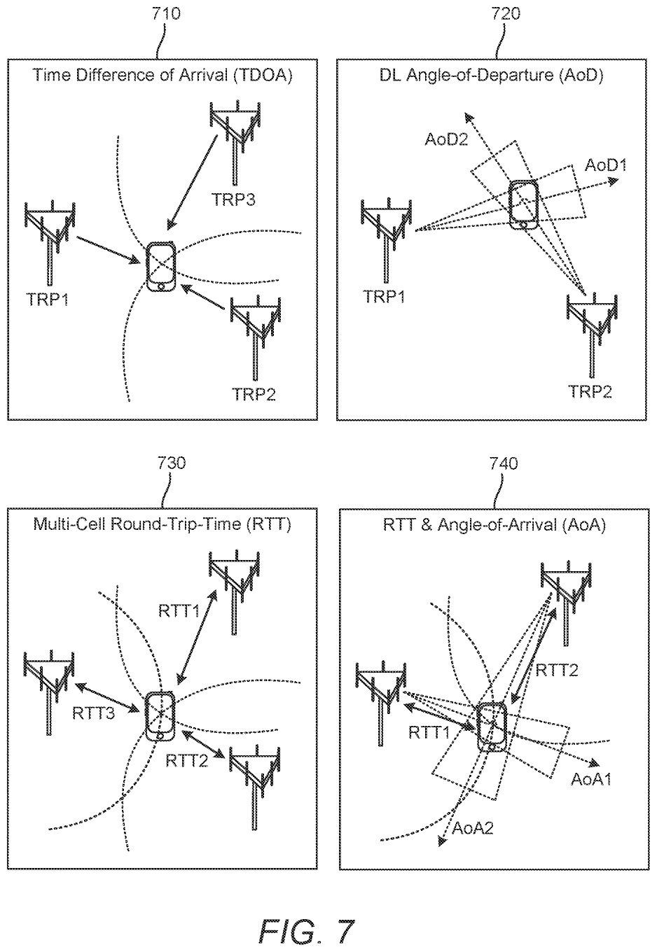

Downlink-based positioning methods include observed time difference of arrival (OTDOA) in LTE, downlink time difference of arrival (DL-TDOA) in NR, and downlink angle-of-departure (DL-AoD) in NR. FIG. 7 illustrates examples of various positioning methods, according to aspects of the disclosure. In an OTDOA or DL-TDOA positioning procedure, illustrated by scenario 710, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity.

More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 720, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements).

Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 730, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 740.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location.

A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

In NR, there may not be precise timing synchronization across the network. Instead, it may be sufficient to have coarse time-synchronization across base stations (e.g., within a cyclic prefix (CP) duration of the orthogonal frequency division multiplexing (OFDM) symbols). RTT-based methods generally only need coarse timing synchronization, and as such, are a preferred positioning method in NR.

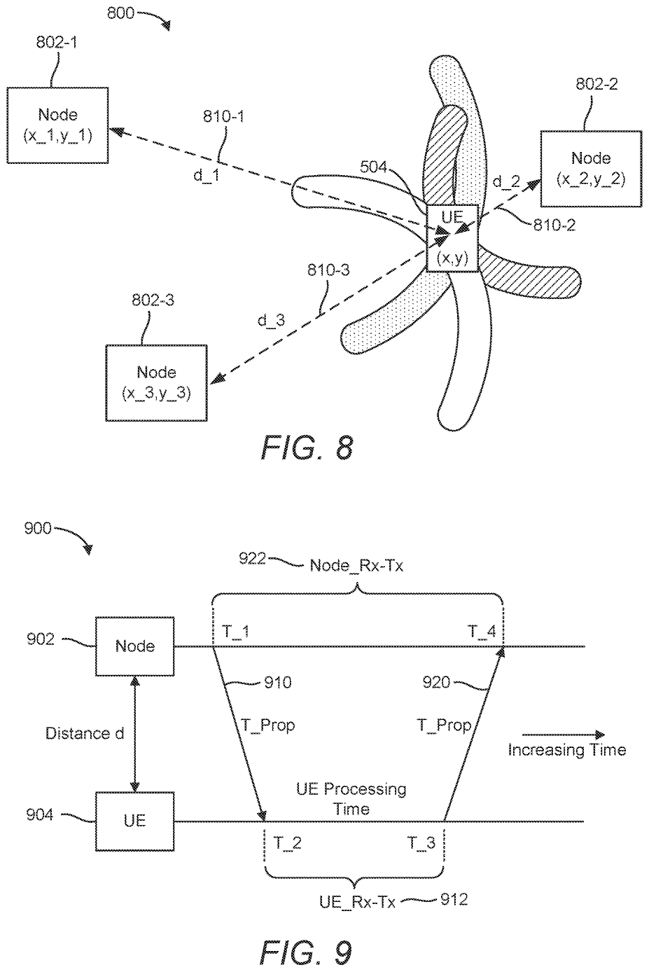

FIG. 8 illustrates an example wireless communications system 800, according to aspects of the disclosure. In the example of FIG. 8, a UE 804 (e.g., any of the UEs described herein) is attempting to calculate an estimate of its location, or assist another entity (e.g., a base station or core network component, another UE, a location server, a third party application, etc.) to calculate an estimate of its location. The UE 804 may transmit and receive wireless signals to and from a plurality of network nodes (labeled “Node”) 802-1, 802-2, and 802-3 (collectively, network nodes 802). The network nodes 802 may include one or more base stations (e.g., any of the base stations described herein), one or more reconfigurable intelligent displays (RIS), one or more positioning beacons, one or more UEs (e.g., connected over sidelinks), etc.

In a network-centric RTT positioning procedure the serving base station (e.g., one of network nodes 802) instructs the UE 804 to measure RTT measurement signals (e.g., PRS) from two or more neighboring network nodes 802 (and typically the serving base station, as at least three network nodes 802 are needed for a two-dimensional location estimate). The involved network nodes 802 transmit RTT measurement signals on low reuse resources (e.g., resources used by the network nodes 802 to transmit system information, where the network nodes 802 are base stations) allocated by the network (e.g., location server 230. LMF 270, SLP 272). The UE 804 records the arrival time (also referred to as the receive time, reception time, time of reception, or time of arrival) of each RTT measurement signal relative to the UE's 804 current downlink timing (e.g., as derived by the UE 804 from a downlink signal received from its serving base station), and transmits a common or individual RTT response signal (e.g., SRS) to the involved network nodes 802 on resources allocated by its serving base station. The UE 804, if it not the positioning entity, reports a UE reception-to-transmission (Rx-Tx) time difference measurement to the positioning entity. The UE Rx-Tx time difference measurement indicates the time difference between the arrival time of each RTT measurement signal at the UE 804 and the transmission time(s) of the RTT response signal(s). Each involved network node 802 also reports, to the positioning entity, a network node Rx-Tx time difference measurement (also referred to as a base station (BS) or gNB Rx-Tx time difference measurement), which indicates the difference between the transmission time of the RTT measurement signal and the reception time of the RTT response signal.

A UE-centric RTT positioning procedure is similar to the network-based procedure, except that the UE 804 transmits uplink RTT measurement signal(s) (e.g., on resources allocated by the serving base station). The uplink RTT measurement signal(s) are measured by multiple network nodes 802 in the neighborhood of the UE 804. Each involved network node 802 responds with a downlink RT response signal and reports a network node Rx-Tx time difference measurement to the positioning entity. The network node Rx-Tx time difference measurement indicates the time difference between the arrival time of the RTT measurement signal at the network node 802 and the transmission time of the RTT response signal. The UE 804, if it is not the positioning entity, reports, for each network node 802, a UE Rx-Tx time difference measurement that indicates the difference between the transmission time of the RTT measurement signal and the reception time of the RTT response signal.

In order to determine the location (x, y) of the UE 804, the positioning entity needs to know the locations of the network nodes 802, which may be represented in a reference coordinate system as (x_k, y_y), where k=1, 2, 3 in the example of FIG. 8. Where the UE 804 is the positioning entity, a location server with knowledge of the network geometry (e.g., location server 230, LMF 270, SLP 272) may provide the locations of the involved network nodes 802 to the UE 804.

The positioning entity determines each distance 810 (d_k, where k=1, 2, 3) between the UE 804 and the respective network node 802 based on the UE Rx-Tx and network node Rx-Tx time difference measurements and the speed of light, as described further below with reference to FIG. 9. Specifically, in the example of FIG. 8, the distance 810-1 between the UE 804 and the network node 802-1 is d_1, the distance 810-2 between the UE 804 and the network node 802-2 is d_2, and the distance 810-3 between the UE 804 and the network node 802-3 is d_3. Once each distance 810 is determined, the positioning entity can solve for the location (x, y) of the UE 804 by using a variety of known geometric techniques, such as trilateration. From FIG. 8, it can be seen that the location of the UE 804 ideally lies at the common intersection of three semicircles, each semicircle being defined by radius dk and center (x_k, y_k), where k=1, 2, 3.

FIG. 9 is a diagram 900 showing example timings of RTT measurement signals exchanged between a network node 902 (labeled “Node”) and a UE 904, according to aspects of the disclosure. The UE 904 may be any of the UEs described herein. The network node 902 may be a base station (e.g., any of the base stations described herein), an RIS, a positioning beacon, another UE (e.g., connected over a sidelink), or the like.

In the example of FIG. 9, the network node 902 (labeled “BS”) sends an RTT measurement signal 910 (e.g., PRS) to the UE 904 at time T_1. The RTT measurement signal 910 has some propagation delay T_Prop as it travels from the network node 902 to the UE 904. At time T_2 (the reception time of the RTT measurement signal 910 at the UE 904), the UE 904 measures the RTT measurement signal 910. After some UE processing time, the UE 904 transmits an RTT response signal 920 (e.g., SRS) at time T_3. After the propagation delay T_Prop, the network node 902 measures the RTT response signal 920 from the UE 904 at time T_4 (the reception time of the RTT response signal 920 at the network node 902).

The UE 904 reports the difference between time T_3 and time T_2 (i.e., the UE's 904 Rx-Tx time difference measurement, shown as UE_Rx-Tx 912) to the positioning entity.

Similarly, the network node 902 reports the difference between time T_4 and time T_1 (i.e., the network node's 902 Rx-Tx time difference measurement, shown as Node_Rx-Tx 922) to the positioning entity. Using these measurements and the known speed of light, the positioning entity can calculate the distance to the UE 904 as d=1/2*c*(Node_Rx-Tx−UE_Rx-Tx)=1/2*c*(T_4−T_1)−1/2*c*(T_3−T_2), where c is the speed of light.

Based on the known location of the network node 902 and the distance between the UE 904 and the network node 902 (and at least two other network nodes 902), the positioning entity can calculate the location of the UE 904. As shown in FIG. 8, the location of the UE 904 lies at the common intersection of three semicircles, each semicircle being defined by a radius of the distance between the UE 904 and a respective network node 902.

In an aspect, the positioning entity may calculate the UE's 804/904 location using a two-dimensional coordinate system: however, the aspects disclosed herein are not so limited, and may also be applicable to determining locations using a three-dimensional coordinate system, if the extra dimension is desired. Additionally, while FIG. 8 illustrates one UE 804 and three network nodes 802 and FIG. 9 illustrates one UE 904 and one network node 902, as will be appreciated, there may be more UEs 804/904 and more network nodes 802/902.

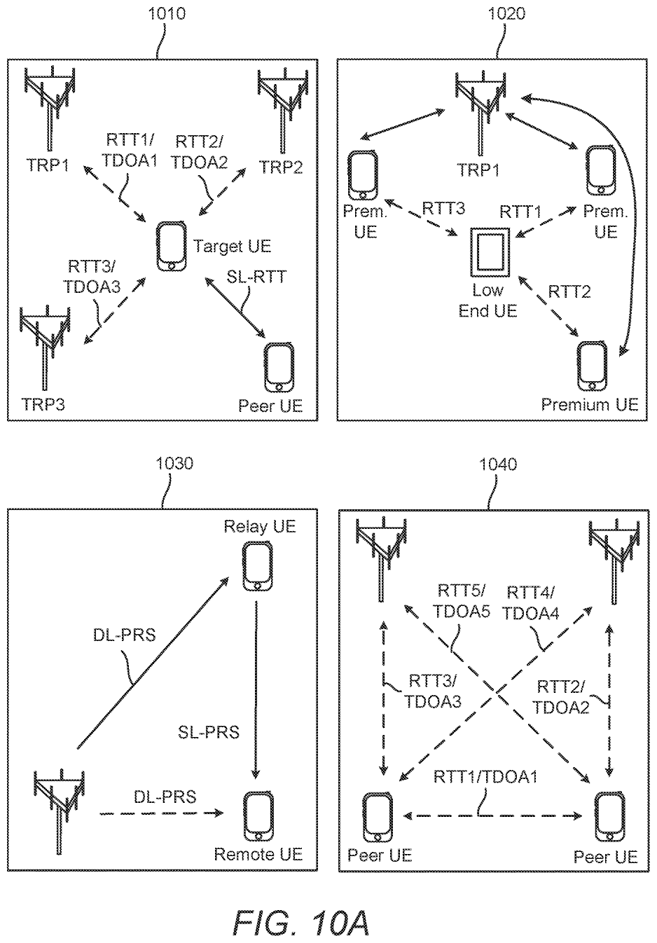

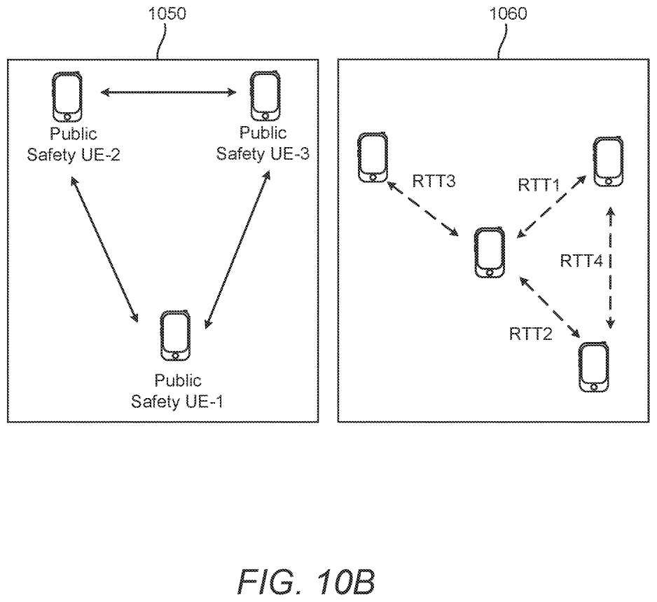

NR supports, or enables, various sidelink positioning techniques. FIG. 10A illustrates various scenarios of interest for sidelink-only or joint Uu and sidelink positioning, according to aspects of the disclosure. In scenario 1010, at least one peer UE with a known location can improve the Uu-based positioning (e.g., multi-cell round-trip-time (RTT), downlink time difference of arrival (DL-TDOA), etc.) of a target UE by providing an additional anchor (e.g., using sidelink RTT (SL-RTT)). In scenario 1020, a low-end (e.g., reduced capacity, or “RedCap”) target UE may obtain the assistance of premium UEs to determine its location using, e.g., sidelink positioning and ranging procedures with the premium UEs. Compared to the low-end UE, the premium UEs may have more capabilities, such as more sensors, a faster processor, more memory, more antenna elements, higher transmit power capability, access to additional frequency bands, or any combination thereof. In scenario 1030, a relay UE (e.g., with a known location) participates in the positioning estimation of a remote UE without performing uplink positioning reference signal (PRS) transmission over the Uu interface. Scenario 1040 illustrates the joint positioning of multiple UEs. Specifically, in scenario 1040, two UEs with unknown positions can be jointly located in non-line-of-sight (NLOS) conditions by utilizing constraints from nearby UEs.

FIG. 10B illustrates additional scenarios of interest for sidelink-only or joint Uu and sidelink positioning, according to aspects of the disclosure. In scenario 1050, UEs used for public safety (e.g., by police, firefighters, and/or the like) may perform peer-to-peer (P2P) positioning and ranging for public safety and other uses. For example, in scenario 1050, the public safety UEs may be out of coverage of a network and determine a location or a relative distance and a relative position among the public safety UEs using sidelink positioning techniques. Similarly, scenario 1060 shows multiple UEs that are out of coverage and determine a location or a relative distance and a relative position using sidelink positioning techniques, such as SL-RTT.

Sidelink communication takes place in transmission or reception resource pools. In the frequency domain, the minimum resource allocation unit is a sub-channel (e.g., a collection of consecutive PRBs in the frequency domain). In the time domain, resource allocation is in one slot intervals. However, some slots are not available for sidelink, and some slots contain feedback resources. In addition, sidelink resources can be (pre)configured to occupy fewer than the 14 symbols of a slot.

Sidelink resources are configured at the radio resource control (RRC) layer. The RRC configuration can be by pre-configuration (e.g., preloaded on the UE) or configuration (e.g., from a serving base station).

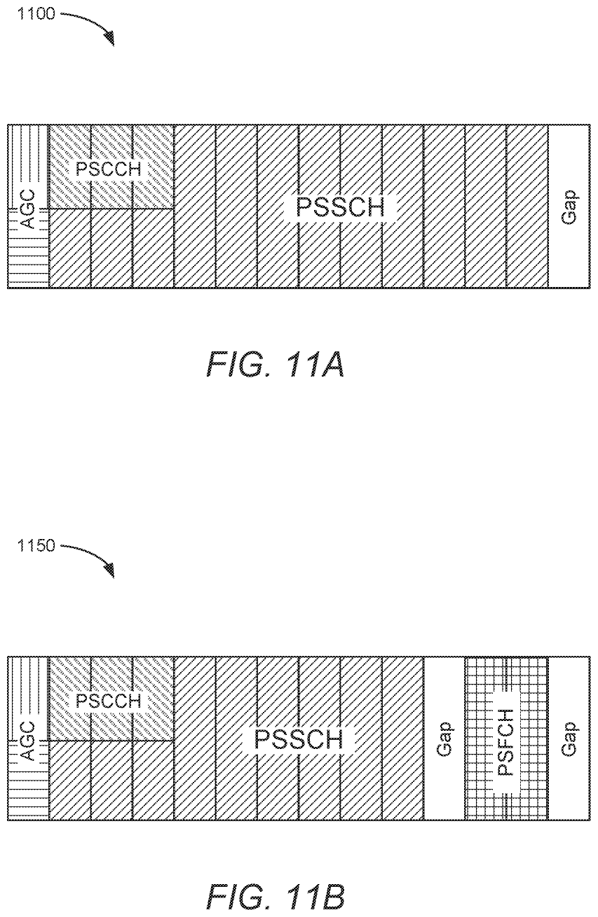

NR sidelinks support hybrid automatic repeat request (HARQ) retransmission. FIG. 11A is a diagram 1100 of an example slot structure without feedback resources, according to aspects of the disclosure. In the example of FIG. 11A, time is represented horizontally and frequency is represented vertically. In the time domain, the length of each block is one orthogonal frequency division multiplexing (OFDM) symbol, and the 14 symbols make up a slot. In the frequency domain, the height of each block is one sub-channel. Currently, the (pre)configured sub-channel size can be selected from the set of {10, 15, 20, 25, 50, 75, 100} physical resource blocks (PRBs).

For a sidelink slot, the first symbol is a repetition of the preceding symbol and is used for automatic gain control (AGC) setting. This is illustrated in FIG. 11A by the vertical and horizontal hashing. As shown in FIG. 11A, for sidelink, the physical sidelink control channel (PSCCH) and the physical sidelink shared channel (PSSCH) are transmitted in the same slot. Similar to the physical downlink control channel (PDCCH), the PSCCH carries control information about sidelink resource allocation and descriptions about sidelink data transmitted to the UE. Likewise, similar to the physical downlink shared channel (PDSCH), the PSSCH carries user data for the UE. In the example of FIG. 11A, the PSCCH occupies half the bandwidth of the sub-channel and only three symbols. Finally, a gap symbol is present after the PSSCH.

FIG. 11B is a diagram 1150 of an example slot structure with feedback resources, according to aspects of the disclosure. In the example of FIG. 11B, time is represented horizontally and frequency is represented vertically. In the time domain, the length of each block is one OFDM symbol, and the 14 symbols make up a slot. In the frequency domain, the height of each block is one sub-channel.

The slot structure illustrated in FIG. 11B is similar to the slot structure illustrated in FIG. 11A, except that the slot structure illustrated in FIG. 11B includes feedback resources. Specifically, two symbols at the end of the slot have been dedicated to the physical sidelink feedback channel (PSFCH). The first PSFCH symbol is a repetition of the second PSFCH symbol for AGC setting. In addition to the gap symbol after the PSSCH, there is a gap symbol after the two PSFCH symbols. Currently, resources for the PSFCH can be configured with a periodicity selected from the set of {0, 1, 2, 4} slots.

The first 13 symbols of a slot in the time domain and the allocated subchannel(s) in the frequency domain form a sidelink resource pool. A sidelink resource pool may include resources for sidelink communication (transmission and/or reception), sidelink positioning (referred to as a resource pool for positioning (RP-P)), or both communication and positioning. A resource pool configured for both communication and positioning is referred to as a “shared” resource pool. In a shared resource pool, the RP-P is indicated by an offset, periodicity, number of consecutive symbols within a slot (e.g., as few as one symbol), and/or the bandwidth within a component carrier (or the bandwidth across multiple component carriers). In addition, the RP-P can be associated with a zone or a distance from a reference location.

A base station (or a UE, depending on the resource allocation mode) can assign, to another UE, one or more resource configurations from the RP-Ps. Additionally or alternatively, a UE (e.g., a relay or a remote UE) can request one or more RP-P configurations, and it can include in the request one or more of the following: (1) its location information (or zone identifier), (2) periodicity, (3) bandwidth, (4) offset, (5) number of symbols, and (6) whether a configuration with “low interference” is needed (which can be determined through an assigned quality of service (QoS) or priority).

A base station or a UE can configure/assign rate matching resources or RP-P for rate matching and/or muting to a sidelink UE such that when a collision exists between the assigned resources and another resource pool that contains data (PSSCH) and/or control (PSCCH), the sidelink UE is expected to rate match, mute, and/or puncture the data, DMRS, and/or CSI-RS within the colliding resources. This would enable orthogonalization between positioning and data transmissions for increased coverage of PRS signals.

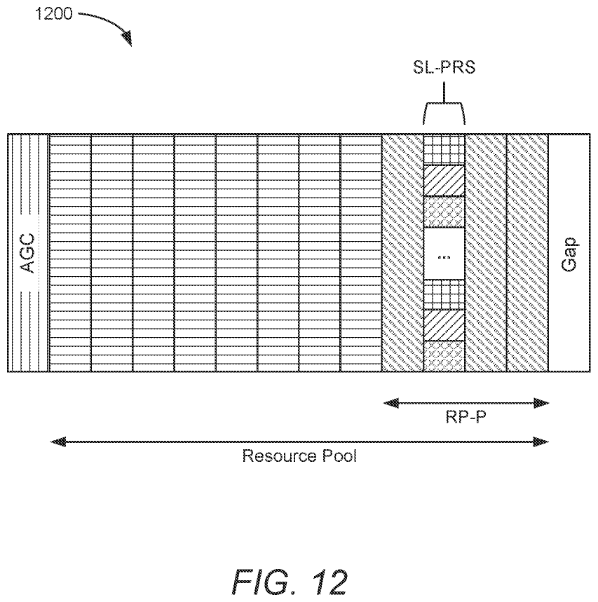

FIG. 12 is a diagram 1200 illustrating an example of a resource pool for positioning configured within a sidelink resource pool for communication (i.e., a shared resource pool), according to aspects of the disclosure. In the example of FIG. 12, time is represented horizontally and frequency is represented vertically. In the time domain, the length of each block is an orthogonal frequency division multiplexing (OFDM) symbol, and the 14 symbols make up a slot. In the frequency domain, the height of each block is a sub-channel.

In the example of FIG. 12, the entire slot (except for the first and last symbols) can be a resource pool for sidelink communication. That is, any of the symbols other than the first and last can be allocated for sidelink communication. However, an RP-P is allocated in the last four pre-gap symbols of the slot. As such, non-sidelink positioning data, such as user data (PSSCH), CSI-RS, and control information, can only be transmitted in the first eight post-AGC symbols and not in the last four pre-gap symbols to prevent a collision with the configured RP-P. The non-sidelink positioning data that would otherwise be transmitted in the last four pre-gap symbols can be punctured or muted, or the non-sidelink data that would normally span more than the eight post-AGC symbols can be rate matched to fit into the eight post-AGC symbols.

Sidelink positioning reference signals (SL-PRS) have been defined to enable sidelink positioning procedures among UEs. Like a downlink PRS (DL-PRS), an SL-PRS resource is composed of one or more resource elements (i.e., one OFDM symbol in the time domain and one subcarrier in the frequency domain). SL-PRS resources have been designed with a comb-based pattern to enable fast Fourier transform (FFT)-based processing at the receiver. SL-PRS resources are composed of unstaggered, or only partially staggered, resource elements in the frequency domain to provide small time of arrival (TOA) uncertainty and reduced overhead of each SL-PRS resource. SL-PRS may also be associated with specific RP-Ps (e.g., certain SL-PRS may be allocated in certain RP-Ps). SL-PRS have also been defined with intra-slot repetition (not shown in FIG. 12) to allow for combining gains (if needed). There may also be inter-UE coordination of RP-Ps to provide for dynamic SL-PRS and data multiplexing while minimizing SL-PRS collisions.

In some designs, UE Rx-Tx Time Difference (T_{UE-RX-TX}) may be defined as follows, e.g.:

TABLE 1

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a TP, |
| | defined by the first detected path in time. |
| | T_{UE-TX} is the UE transmit timing of uplink subframe #j that is closest |
| | in time to the subframe #i received from the TP. |
| | Multiple DL PRS resources can be used to determine the start of one |
| | subframe of the first arrival path of the TP. |
| | For frequency range 1, the reference point for T_{UE-RX} measurement |
| | shall be the Rx antenna connector of the UE and the reference point |
| | for T_{UE-TX} measurement shall be the Tx antenna connector of the UE. |
| | For frequency range 2, the reference point for T_{UE-RX} measurement |
| | shall be the Rx antenna of the UE and the reference point for T_{UE-TX} |
| | measurement shall be the Tx antenna of the UE. |
| Applicable for | RRC_CONNECTED |
| | RRC_INACTIVE |

In an aspect, this definition of UE Rx-Tx Time Difference (T_{UE-RX-TX}) may ensure that a porting range of UE Rx-Tx Time Difference (T_{UE-RX-TX}) is within −0.5 to 0.5 ms.

In some designs, gNB Rx-Tx Time Difference (T_{gNB-RX-TX}) may be defined as follows, e.g.:

TABLE 2

| | |
|---|---|
| Definition | The gNB Rx − Tx time difference is defined as T_{gNB-RX} − T_{gNB-TX} |
| | Where: |
| | T_{gNB-RX} is the Transmission and Reception Point (TRP) received |
| | timing of uplink subframe #i containing SRS associated with UE, |
| | defined by the first detected path in time. |
| | T_{gNB-TX} is the TRP transmit timing of downlink subframe #j that is |
| | closest in time to the subframe #i received from the UE. |
| | Multiple SRS resources for positioning can be used to determine the |
| | start of one subframe containing SRS. |
| | The reference point for T_{gNB-RX} shall be: |
| | for type 1-C base station TS 38.104: the Rx antenna connector, |
| | for type 1-O or 2-O base station TS 38.104: the Rx antenna (i.e. |
| | the centre location of the radiating region of the Rx antenna), |
| | for type 1-H base station TS 38.104: the Rx Transceiver Array |
| | Boundary connector. |
| | The reference point for_{gNB-TX} shall be: |
| | for type 1-C base station TS 38.104: the Tx antenna connector, |
| | for type 1-O or 2-O base station TS 38.104: the Tx antenna (i.e. |
| | the centre location of the radiating region of the Tx antenna), |
| | for type 1-H base station TS 38.104: the Tx Transceiver Array |
| | Boundary connector. |

In an aspect, this definition of gNB Rx-Tx Time Difference (T_{gNB-RX-TX}) may ensure that a porting range of gNB Rx-Tx Time Difference (T_{gNB-RX-TX}) is within −0.5 to 0.5 ms.

For sidelink, SL Rx-Tx Time Difference (T_{SL-RX-TX}) may be measured in different ways.

In a first example (“Option 1”), the UE may be capable of measuring SL Rx-Tx Time Difference (T_{SL-RX-TX}) based on an actual SL-PRS transmission time. In an example of SL Rx-Tx Time Difference (T_{SL-RX-TX}) under Option 1, SL Rx-Tx Time Difference (T_{SL-RX-TX}) may be defined as mod(TUE-RX−TUE-TX+0.5 ms, 1 ms)−0.5 ms, where:
TUE-RX is the UE received timing of sidelink subframe #i from another UE, defined by the first detected path in time.
TUE-TX is the UE transmit timing of sidelink subframe #j in which the UE transmits SL-PRS.

Note that SL-PRS may not be transmitted at each configured SL-PRS occasion. Hence, the location of subframe #j in Option 1 is not guaranteed, as some number of transmit subframes without SL-PRS transmission may occur between subframes #i and #i.

In a second example (“Option 2”), similar to UE Rx-Tx Time Difference in 3GPP Rel. 16-17, the UE may be capable of measuring SL Rx-Tx Time Difference (T_{SL-RX-TX}) defined as TUE-RX-TUE-TX, where:
TUE-RX is the UE received timing of sidelink subframe #i from another Tx UE, defined by the first detected path in time.
TUE-TX is the UE transmit timing of sidelink subframe #j that is closest in time to the subframe #i received from the Tx UE

Note that in some designs, subframe #j can be subframe #i. Here, sidelink subframe #j may not include a configured SL-PRS occasion. Also, even if SL-PRS occasion is configured in sidelink subframe #j, the UE may not activate (i.e., transmit SL-PRS upon) the SL-PRS occasion.

In a third example (“Option 3”), the UE may be capable of measuring SL Rx-Tx Time Difference (T_{SL-RX-TX}) in accordance with both Option 1 and Option 2.

In some designs, the UE may report SL Rx-Tx Time Difference capability (i.e., support for one or more of Options 1 or 2 or 3) to a position estimation entity, such as an LMF (e.g., for network-assisted position estimation) or the UE or another UE (e.g., for UE-based position estimation). In some designs, SL Rx-Tx Time Difference capability may be defined per band.

Aspects of the disclosure are directed to determination of a SL Rx-Tx time difference measurement type (e.g., Option 1 or Option 2) of in a scenario where a UE supports both Options 1-2 (or Option 3). In some aspects, the determination of the SL Rx-Tx time difference measurement type may be based on an explicit network-designated SL Rx-Tx time difference measurement type associated with the measurement request, or an autonomous selection at the UE based on one or more rules associated with one or more criteria. Such aspects may provide various technical advantages, such as more flexibility in terms of SL Rx-Tx time difference measurement reporting for SL-based position estimation of the UE. For example, one SL Rx-Tx time difference measurement type may in certain scenarios be more appropriate than the other SL Rx-Tx time difference measurement type (e.g., based on criteria such as UE mobility, inter-subframe time difference, RSRP change, etc.), and selecting the more appropriate SL Rx-Tx time difference measurement type may result in less positioning latency, more positioning accuracy, less power consumption at the UE, and so on.

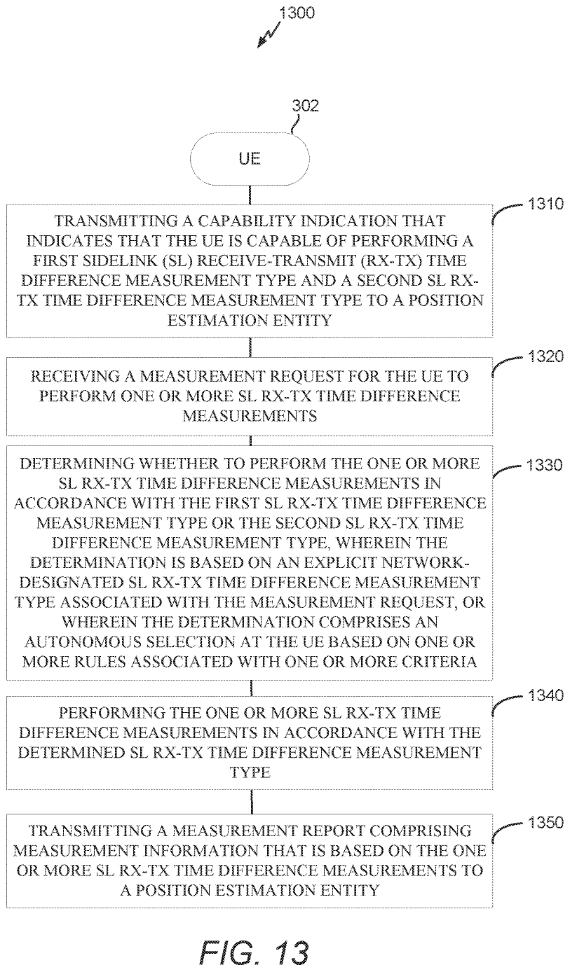

FIG. 13 illustrates an exemplary process 1300 of communications according to an aspect of the disclosure. The process 1300 of FIG. 13 is performed by a UE, such as UE 302.

Referring to FIG. 13, at 1310. UE 302 (e.g., transmitter 314 or 324, etc.) transmits a capability indication that indicates that the UE is capable of performing a first sidelink (SL) receive-transmit (Rx-Tx) time difference measurement type and a second SL Rx-Tx time difference measurement type to a position estimation entity. In some designs (e.g., see Option 1, above), the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE. In some designs (e.g., see Option 2, above), the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe.

Referring to FIG. 13, at 1320, UE 302 (e.g., receiver 312 or 322, etc.) receives a measurement request for the UE to perform one or more SL Rx-Tx time difference measurements. For example, the measurement request may be received from a position estimation entity.

Referring to FIG. 13, at 1330, UE 302 (e.g., processor(s) 332, SL Rx-Tx Component 342, etc.) determines whether to perform the one or more SL Rx-Tx time difference measurements in accordance with the first SL Rx-Tx time difference measurement type or the second SL Rx-Tx time difference measurement type. In some designs, the determination is based on an explicit network-designated SL Rx-Tx time difference measurement type associated with the measurement request. In other designs, the determination comprises an autonomous selection at the UE based on one or more rules associated with one or more criteria.

Referring to FIG. 13, at 1340, UE 302 (e.g., receiver 312 or 322, transmitter 314 or 324, processor(s) 332, SL Rx-Tx Component 342, etc.) performs the one or more SL Rx-Tx time difference measurements in accordance with the determined SL Rx-Tx time difference measurement type. For example, the

Referring to FIG. 13, at 1350, UE 302 (e.g., transmitter 314 or 324, etc.) transmits a measurement report comprising measurement information that is based on the one or more SL Rx-Tx time difference measurements to a position estimation entity.

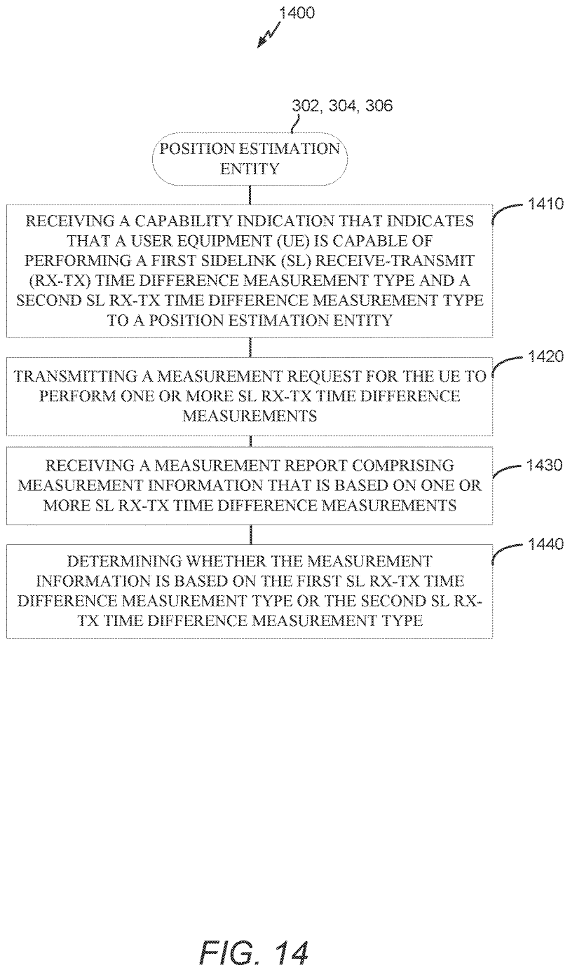

FIG. 14 illustrates an exemplary process 1400 of communications according to an aspect of the disclosure. The process 1400 of FIG. 14 is performed by a position estimation entity. In some designs, the position estimation entity may correspond to a network component (e.g., an LMF integrated at gNB/BS 304 or O-RAN component or a remote location server such as network entity 306, etc.). In other designs, the position estimation entity may correspond to another UE (e.g., sidelink anchor UE) or to the target UE itself (e.g., for UE-based position estimation, in which case any Rx/Tx operations between the UE and the position estimation entity may correspond to transfer of information between different logical components of the UE over a data bus, etc.). In a further aspect, the process 1400 of FIG. 14 at the position estimation entity may correspond to a process performed in parallel with the process 1300 of FIG. 13 at the UE.

Referring to FIG. 14, at 1410, the position estimation entity (e.g., receiver 312 or 322 or 352 or 362 or data bus 334 or data bus 382 or network transceiver(s) 380 or 390, etc.) receives a capability indication that indicates that a user equipment (UE) is capable of performing a first sidelink (SL) receive-transmit (Rx-Tx) time difference measurement type and a second SL Rx-Tx time difference measurement type to a position estimation entity. In some designs (e.g., see Option 1, above), the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE. In some designs (e.g., see Option 2, above), the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe.

Referring to FIG. 14, at 1420, the position estimation entity (e.g., transmitter 314 or 324 or 354 or 364, data bus 334 or data bus 382, network transceiver(s) 380 or 390, etc.) transmits a measurement request for the UE to perform one or more SL Rx-Tx time difference measurements.

Referring to FIG. 14, at 1430, the position estimation entity (e.g., receiver 312 or 322 or 352 or 362 or data bus 334 or data bus 382 or network transceiver(s) 380 or 390, etc.) receives a measurement report comprising measurement information that is based on one or more SL Rx-Tx time difference measurements.

Referring to FIG. 14, at 1440, the position estimation entity (e.g., processor(s) 332 or 384 or 394, SL Rx-Tx Component 342 or 388 or 398, etc.) determines whether the measurement information is based on the first SL Rx-Tx time difference measurement type or the second SL Rx-Tx time difference measurement type. In an aspect, the measurement information may then be used to help derive a position estimate of the UE.

Referring to FIGS. 13-14, in some designs, the determination at 1330 is based on the explicit network-designated SL Rx-Tx time difference measurement type associated with the measurement request. For example, UE or LMF may send an explicit request to a target UE of whether to perform measurements and report a measurement according to one SL Rx-Tx time difference measurement definition or the other.

Referring to FIGS. 13-14, in some designs, the one or more rules may include selecting a default SL Rx-Tx time difference measurement type if the measurement request is not associated with the explicit network-designated SL Rx-Tx time difference measurement type. For example, if measurement request does not include information on whether one SL Rx-Tx time difference measurement definition or the other SL Rx-Tx time difference measurement should be used, one SL Rx-Tx time difference measurement definition (e.g., Option 2) may be considered the legacy and should be used by default.

Referring to FIGS. 13-14, in some designs, the one or more criteria may include a time difference between the first subframe and the second subframe. In a further aspect, the one or more rules may include selecting the first SL Rx-Tx time difference measurement type if the time difference exceeds a time difference threshold, and selecting the second SL Rx-Tx time difference measurement type if the time difference does not exceed the time difference threshold. For example, if a SL-PRS Tx is too far away from a SL-PRS Rx (e.g., the threshold could be configured by the network, by another UE, or may be pre-configured, or may be specified), the UE reports the measurement using Option 1. In some designs, if SL-PRS Tx is dropped, and the UE was expected to use the Option 2 definition, then the UE can instead report a measurement with Option 1 definition (e.g., the network or another UE configures the measuring UE for such behavior).

Referring to FIGS. 13-14, in some designs, the one or more criteria may include UE mobility. In a further aspect, the one or more rules may include selecting the first SL Rx-Tx time difference measurement type if the UE mobility exceeds a UE mobility threshold, and selecting the second SL Rx-Tx time difference measurement type if the UE mobility does not the UE mobility threshold. For example, UE that is in a high mobility scenario may pick by implementation to use Option 1 definition since Option 1 is more robust to high UE mobility. A UE mobility threshold on mobility (e.g. slow, medium, high) may be configured to the UE. In other designs, the one or more criteria may include a reference signal received power (RSRP) change. In a further aspect, the one or more rules may include selecting the first SL Rx-Tx time difference measurement type if the RSRP change exceeds a RSRP change threshold, and selecting the second SL Rx-Tx time difference measurement type if the RSRP change does not exceed the RSRP change threshold.

Referring to FIGS. 13-14, in some designs, the one or more criteria may include a timing change parameter. In a further aspect, the one or more rules may include selecting the first SL Rx-Tx time difference measurement type if a timing change is performed, and selecting the second SL Rx-Tx time difference measurement type if the timing change is not performed. In some designs, the timing change parameter is associated with timing changes in response to a timing advance (TA) command, an autonomous adjustment by the UE, or a combination thereof. For example, if there is a timing changing (e.g. UE receives a TA command, or the UE performs autonomous adjustment) between a Rx of SL-PRS and the Tx of a SL-PRS, then a UE may use the Option 1 definition instead of the Option 2 definition.

Referring to FIGS. 13-14, in some designs, the one or more criteria may include one or more criteria comprises a measurement value difference between (i) the UE received timing associated with the first subframe comprising the first PRS from the another device and (iii) the second UE transmit timing of the third subframe. In a further aspect, the one or more rules may include selecting the first SL Rx-Tx time difference measurement type if the measurement value difference exceeds a measurement value difference threshold, and selecting the second SL Rx-Tx time difference measurement type if the measurement value difference does not exceed the measurement value difference threshold. For example UE is required to pick to report a measurement with Option 1 definition if the value difference of the measurements resulting with different definition is larger than a threshold. The threshold could be configured by the network, by another UE, or may be pre-configured, or may be specified (pre-defined in standard).

Referring to FIGS. 13-14, in some designs, the one or more criteria, the one or more rules, or both, comprise at least one criterion, at least one rule, or both, that is pre-defined, or pre-configured before a positioning session of the UE is initiated, or configured for the positioning session by the positioning estimation entity, a network component or another UE, or any combination thereof.

Referring to FIGS. 13-14, in some designs, the determined SL Rx-Tx time difference measurement type is associated with a resource pool, or the determined SL Rx-Tx time difference measurement type is associated with a SL-PRS resource or SL-PRS resource set. For example, one SL Rx-Tx time difference measurement type or definition or the other is picked can be (pre-)configured on a resource pool level. For example, one SL Rx-Tx time difference measurement type or definition or the other is picked can be (pre-)configured on a SL-PRS resource level or SL-PRS resource set level.

Referring to FIGS. 13-14, in some designs, the determination is made autonomously at the UE based on the one or more rules associated with the one or more criteria, and the measurement report includes an indication of the determined SL Rx-Tx time difference measurement type. In some designs, the indication of the of the determined SL Rx-Tx time difference measurement type is based on whether the measurement information comprises a timestamp associated with UE transmit timing. In a further example, the indication indicates the first SL Rx-Tx time difference measurement type if the measurement information comprises the timestamp, and the indication indicates the second SL Rx-Tx time difference measurement type if the measurement information does not comprise the timestamp. For example, if a UE includes a timestamp for the SL-PRS transmission associated with a UE Rx-Tx measurement, it is assumed that it is Option 1 definition that was used.

Referring to FIGS. 13-14, in some designs, all measurement information in the measurement report is associated with the determined SL Rx-Tx time difference measurement type. For example, UE may be required to pick a single definition for all the SL Rx-Tx measurements that are included in a measurement report. Alternatively, in another example, the measurement report further comprises additional measurement information that is based on at least one SL Rx-Tx time difference measurement in accordance with a respective SL Rx-Tx time difference measurement type other than the determined SL Rx-Tx time difference measurement type. In this case, UE may be able to pick a different SL Rx-Tx time difference measurement type or definition for different SL Rx-Tx measurements in the same measurement report.

Referring to FIGS. 13-14, in some designs, the determined SL Rx-Tx time difference measurement type is the first SL Rx-Tx time difference measurement type. In an example, for each of the one or more SL Rx-Tx time difference measurements in accordance with the first SL Rx-Tx time difference measurement type: the first PRS and the second PRS are SL-PRSs, or the first PRS is downlink PRS (DL-PRS) and the second PRS is SL-PRS, or the first PRS is SL-PRS and the second PRS is uplink (UL-PRS). In some designs, the determined SL Rx-Tx time difference measurement type is the second SL Rx-Tx time difference measurement type. In an example, for each of the one or more SL Rx-Tx time difference measurements in accordance with the second SL Rx-Tx time difference measurement type: the first PRS is SL-PRS and the third subframe is configured for SL, or the first PRS is downlink PRS (DL-PRS) and the third subframe is configured for SL, or the first PRS is SL-PRS and the third subframe is configured for uplink (UL). In other words, a SL Rx-Tx time difference measurement (of either type) may be based only on SL-PRS measurements (or subframes), or alternatively based on one SL-PRS measurement/subframe and one Uu (DL or UL) PRS measurement or subframe.

Referring to FIGS. 13-14, in some designs, the position estimation entity provisions the UE with the one or more rules associated with one or more criteria for autonomous SL Rx-Tx time difference measurement type selection at the UE. In other designs,

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of operating a user equipment (UE), comprising: transmitting a capability indication that indicates that the UE is capable of performing a first sidelink (SL) receive-transmit (Rx-Tx) time difference measurement type and a second SL Rx-Tx time difference measurement type to a position estimation entity, wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe; receiving a measurement request for the UE to perform one or more SL Rx-Tx time difference measurements; and determining whether to perform the one or more SL Rx-Tx time difference measurements in accordance with the first SL Rx-Tx time difference measurement type or the second SL Rx-Tx time difference measurement type, wherein the determination is based on an explicit network-designated SL Rx-Tx time difference measurement type associated with the measurement request, or wherein the determination comprises an autonomous selection at the UE based on one or more rules associated with one or more criteria; performing the one or more SL Rx-Tx time difference measurements in accordance with the determined SL Rx-Tx time difference measurement type; and transmitting a measurement report comprising measurement information that is based on the one or more SL Rx-Tx time difference measurements to a position estimation entity.

Clause 2. The method of clause 1, wherein the determination is based on the explicit network-designated SL Rx-Tx time difference measurement type associated with the measurement request.

Clause 3. The method of any of clauses 1 to 2, wherein the one or more rules comprise: selecting a default SL Rx-Tx time difference measurement type if the measurement request is not associated with the explicit network-designated SL Rx-Tx time difference measurement type.

Clause 4. The method of any of clauses 1 to 3, wherein the one or more criteria comprise a time difference between the first subframe and the second subframe.

Clause 5. The method of clause 4, wherein the one or more rules comprise: selecting the first SL Rx-Tx time difference measurement type if the time difference exceeds a time difference threshold, and selecting the second SL Rx-Tx time difference measurement type if the time difference does not exceed the time difference threshold.

Clause 6. The method of any of clauses 1 to 5, wherein the one or more criteria comprise UE mobility.

Clause 7. The method of clause 6, wherein the one or more rules comprise: selecting the first SL Rx-Tx time difference measurement type if the UE mobility exceeds a UE mobility threshold, and selecting the second SL Rx-Tx time difference measurement type if the UE mobility does not the UE mobility threshold.

Clause 8. The method of any of clauses 1 to 7, wherein the one or more criteria comprise a reference signal received power (RSRP) change.

Clause 9. The method of clause 8, wherein the one or more rules comprise: selecting the first SL Rx-Tx time difference measurement type if the RSRP change exceeds a RSRP change threshold, and selecting the second SL Rx-Tx time difference measurement type if the RSRP change does not exceed the RSRP change threshold.

Clause 10. The method of any of clauses 1 to 9, wherein the one or more criteria comprise a timing change parameter.

Clause 11. The method of clause 10, wherein the one or more rules comprise: selecting the first SL Rx-Tx time difference measurement type if a timing change is performed, and selecting the second SL Rx-Tx time difference measurement type if the timing change is not performed.

Clause 12. The method of any of clauses 10 to 11, wherein the timing change parameter is associated with timing changes in response to a timing advance (TA) command, an autonomous adjustment by the UE, or a combination thereof.

Clause 13. The method of any of clauses 1 to 12, wherein the one or more criteria comprises a measurement value difference between (i) the UE received timing associated with the first subframe comprising the first PRS from the another device and (iii) the second UE transmit timing of the third subframe.

Clause 14. The method of clause 13, wherein the one or more rules comprise: selecting the first SL Rx-Tx time difference measurement type if the measurement value difference exceeds a measurement value difference threshold, and selecting the second SL Rx-Tx time difference measurement type if the measurement value difference does not exceed the measurement value difference threshold.

Clause 15. The method of any of clauses 1 to 14, wherein the one or more criteria, the one or more rules, or both, comprise at least one criterion, at least one rule, or both, that is: pre-defined, or pre-configured before a positioning session of the UE is initiated, or configured for the positioning session by the positioning estimation entity, a network component or another UE, or any combination thereof.

Clause 16. The method of any of clauses 1 to 15, wherein the determined SL Rx-Tx time difference measurement type is associated with a resource pool, or wherein the determined SL Rx-Tx time difference measurement type is associated with a SL-PRS resource or SL-PRS resource set.

Clause 17. The method of any of clauses 1 to 16, wherein the determination is made autonomously at the UE based on the one or more rules associated with the one or more criteria, and wherein the measurement report comprises an indication of the determined SL Rx-Tx time difference measurement type.

Clause 18. The method of clause 17, wherein the indication of the of the determined SL Rx-Tx time difference measurement type is based on whether the measurement information comprises a timestamp associated with UE transmit timing.

Clause 19. The method of clause 18, wherein the indication indicates the first SL Rx-Tx time difference measurement type if the measurement information comprises the timestamp, and wherein the indication indicates the second SL Rx-Tx time difference measurement type if the measurement information does not comprise the timestamp.

Clause 20. The method of any of clauses 1 to 19, wherein all measurement information in the measurement report is associated with the determined SL Rx-Tx time difference measurement type, or wherein the measurement report further comprises additional measurement information that is based on at least one SL Rx-Tx time difference measurement in accordance with a respective SL Rx-Tx time difference measurement type other than the determined SL Rx-Tx time difference measurement type.

Clause 21. The method of any of clauses 1 to 20, wherein the determined SL Rx-Tx time difference measurement type is the first SL Rx-Tx time difference measurement type.

Clause 22. The method of clause 21, wherein, for each of the one or more SL Rx-Tx time difference measurements in accordance with the first SL Rx-Tx time difference measurement type: the first PRS and the second PRS are SL-PRSs, or the first PRS is downlink PRS (DL-PRS) and the second PRS is SL-PRS, or the first PRS is SL-PRS and the second PRS is uplink (UL-PRS).

Clause 23. The method of any of clauses 1 to 22, wherein the determined SL Rx-Tx time difference measurement type is the second SL Rx-Tx time difference measurement type.

Clause 24. The method of any of clauses 21 to 23, wherein, for each of the one or more SL Rx-Tx time difference measurements in accordance with the second SL Rx-Tx time difference measurement type: the first PRS is SL-PRS and the third subframe is configured for SL, or the first PRS is downlink PRS (DL-PRS) and the third subframe is configured for SL, or the first PRS is SL-PRS and the third subframe is configured for uplink (UL).

Clause 25. A method of operating a position estimation entity, comprising: receiving a capability indication that indicates that a user equipment (UE) is capable of performing a first sidelink (SL) receive-transmit (Rx-Tx) time difference measurement type and a second SL Rx-Tx time difference measurement type to a position estimation entity, wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe; transmitting a measurement request for the UE to perform one or more SL Rx-Tx time difference measurements, receiving a measurement report comprising measurement information that is based on one or more SL Rx-Tx time difference measurements; and determining whether the measurement information is based on the first SL Rx-Tx time difference measurement type or the second SL Rx-Tx time difference measurement type.

Clause 26. The method of clause 25, wherein the determination is based on which of the first SL Rx-Tx time difference measurement type or the second SL Rx-Tx time difference measurement type is explicitly designated by the position estimation entity to the UE, or wherein the determination is based on an indication in the measurement report.

Clause 27. The method of any of clauses 25 to 26, further comprising: provisioning the UE with one or more rules associated with one or more criteria for autonomous SL Rx-Tx time difference measurement type selection at the UE.

Clause 28. The method of any of clauses 25 to 27, wherein, the determined SL Rx-Tx time difference measurement type is the first SL Rx-Tx time difference measurement type, and for each of the one or more SL Rx-Tx time difference measurements in accordance with the first SL Rx-Tx time difference measurement type: the first PRS and the second PRS are SL-PRSs, or the first PRS is downlink PRS (DL-PRS) and the second PRS is SL-PRS, or the first PRS is SL-PRS and the second PRS is uplink (UL-PRS), or wherein, the determined SL Rx-Tx time difference measurement type is the second SL Rx-Tx time difference measurement type, and, for each of the one or more SL Rx-Tx time difference measurements in accordance with the second SL Rx-Tx time difference measurement type: the first PRS is SL-PRS and the third subframe is configured for SL, or the first PRS is DL-PRS and the third subframe is configured for SL, or the first PRS is SL-PRS and the third subframe is configured for UL.

Clause 29. A user equipment (UE), comprising: a memory; and at least one processor communicatively coupled to the memory, the at least one processor configured to: transmit a capability indication that indicates that the UE is capable of performing a first sidelink (SL) receive-transmit (Rx-Tx) time difference measurement type and a second SL Rx-Tx time difference measurement type to a position estimation entity, wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe; receive a measurement request for the UE to perform one or more SL Rx-Tx time difference measurements, and determine whether to perform the one or more SL Rx-Tx time difference measurements in accordance with the first SL Rx-Tx time difference measurement type or the second SL Rx-Tx time difference measurement type, wherein the determination is based on an explicit network-designated SL Rx-Tx time difference measurement type associated with the measurement request, or wherein the determination comprises an autonomous selection at the UE based on one or more rules associated with one or more criteria; perform the one or more SL Rx-Tx time difference measurements in accordance with the determined SL Rx-Tx time difference measurement type; and transmit a measurement report comprising measurement information that is based on the one or more SL Rx-Tx time difference measurements to a position estimation entity.

Clause 30. The UE of clause 29, wherein the determination is based on the explicit network-designated SL Rx-Tx time difference measurement type associated with the measurement request.

Clause 31. The UE of any of clauses 29 to 30, wherein the one or more rules comprise: select a default SL Rx-Tx time difference measurement type if the measurement request is not associated with the explicit network-designated SL Rx-Tx time difference measurement type.

Clause 32. The UE of any of clauses 29 to 31, wherein the one or more criteria comprise a time difference between the first subframe and the second subframe.

Clause 33. The UE of clause 32, wherein the one or more rules comprise: select the first SL Rx-Tx time difference measurement type if the time difference exceeds a time difference threshold, and select the second SL Rx-Tx time difference measurement type if the time difference does not exceed the time difference threshold.

Clause 34. The UE of any of clauses 29 to 33, wherein the one or more criteria comprise UE mobility.

Clause 35. The UE of clause 34, wherein the one or more rules comprise: select the first SL Rx-Tx time difference measurement type if the UE mobility exceeds a UE mobility threshold, and select the second SL Rx-Tx time difference measurement type if the UE mobility does not the UE mobility threshold.

Clause 36. The UE of any of clauses 29 to 35, wherein the one or more criteria comprise a reference signal received power (RSRP) change.

Clause 37. The UE of clause 36, wherein the one or more rules comprise: select the first SL Rx-Tx time difference measurement type if the RSRP change exceeds a RSRP change threshold, and select the second SL Rx-Tx time difference measurement type if the RSRP change does not exceed the RSRP change threshold.

Clause 38. The UE of any of clauses 29 to 37, wherein the one or more criteria comprise a timing change parameter.

Clause 39. The UE of clause 38, wherein the one or more rules comprise: select the first SL Rx-Tx time difference measurement type if a timing change is performed, and select the second SL Rx-Tx time difference measurement type if the timing change is not performed.

Clause 40. The UE of any of clauses 38 to 39, wherein the timing change parameter is associated with timing changes in response to a timing advance (TA) command, an autonomous adjustment by the UE, or a combination thereof.

Clause 41. The UE of any of clauses 29 to 40, wherein the one or more criteria comprises a measurement value difference between (i) the UE received timing associated with the first subframe comprising the first PRS from the another device and (iii) the second UE transmit timing of the third subframe.

Clause 42. The UE of clause 41, wherein the one or more rules comprise: select the first SL Rx-Tx time difference measurement type if the measurement value difference exceeds a measurement value difference threshold, and select the second SL Rx-Tx time difference measurement type if the measurement value difference does not exceed the measurement value difference threshold.

Clause 43. The UE of any of clauses 29 to 42, wherein the one or more criteria, the one or more rules, or both, comprise at least one criterion, at least one rule, or both, that is: -defined, or -configured before a positioning session of the UE is initiated, or configured for the positioning session by the positioning estimation entity, a network component or another UE, or any combination thereof.

Clause 44. The UE of any of clauses 29 to 43, wherein the determined SL Rx-Tx time difference measurement type is associated with a resource pool, or wherein the determined SL Rx-Tx time difference measurement type is associated with a SL-PRS resource or SL-PRS resource set.

Clause 45. The UE of any of clauses 29 to 44, wherein the determination is made autonomously at the UE based on the one or more rules associated with the one or more criteria, and wherein the measurement report comprises an indication of the determined SL Rx-Tx time difference measurement type.

Clause 46. The UE of clause 45, wherein the indication of the of the determined SL Rx-Tx time difference measurement type is based on whether the measurement information comprises a timestamp associated with UE transmit timing.

Clause 47. The UE of clause 46, wherein the indication indicates the first SL Rx-Tx time difference measurement type if the measurement information comprises the timestamp, and wherein the indication indicates the second SL Rx-Tx time difference measurement type if the measurement information does not comprise the timestamp.

Clause 48. The UE of any of clauses 29 to 47, wherein all measurement information in the measurement report is associated with the determined SL Rx-Tx time difference measurement type, or wherein the measurement report further comprises additional measurement information that is based on at least one SL Rx-Tx time difference measurement in accordance with a respective SL Rx-Tx time difference measurement type other than the determined SL Rx-Tx time difference measurement type.

Clause 49. The UE of any of clauses 29 to 48, wherein the determined SL Rx-Tx time difference measurement type is the first SL Rx-Tx time difference measurement type.

Clause 50. The UE of clause 49, wherein, for each of the one or more SL Rx-Tx time difference measurements in accordance with the first SL Rx-Tx time difference measurement type: the first PRS and the second PRS are SL-PRSs, or the first PRS is downlink PRS (DL-PRS) and the second PRS is SL-PRS, or the first PRS is SL-PRS and the second PRS is uplink (UL-PRS).

Clause 51. The UE of any of clauses 29 to 50, wherein the determined SL Rx-Tx time difference measurement type is the second SL Rx-Tx time difference measurement type.

Clause 52. The UE of any of clauses 49 to 51, wherein, for each of the one or more SL Rx-Tx time difference measurements in accordance with the second SL Rx-Tx time difference measurement type: the first PRS is SL-PRS and the third subframe is configured for SL, or the first PRS is downlink PRS (DL-PRS) and the third subframe is configured for SL, or the first PRS is SL-PRS and the third subframe is configured for uplink (UL).

Clause 53. A position estimation entity, comprising: a memory; and at least one processor communicatively coupled to the memory, the at least one processor configured to: receive a capability indication that indicates that a user equipment (UE) is capable of performing a first sidelink (SL) receive-transmit (Rx-Tx) time difference measurement type and a second SL Rx-Tx time difference measurement type to a position estimation entity, wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe; transmit a measurement request for the UE to perform one or more SL Rx-Tx time difference measurements: receive a measurement report comprising measurement information that is based on one or more SL Rx-Tx time difference measurements; and determine whether the measurement information is based on the first SL Rx-Tx time difference measurement type or the second SL Rx-Tx time difference measurement type.

Clause 54. The position estimation entity of clause 53, wherein the determination is based on which of the first SL Rx-Tx time difference measurement type or the second SL Rx-Tx time difference measurement type is explicitly designated by the position estimation entity to the UE, or wherein the determination is based on an indication in the measurement report.

Clause 55. The position estimation entity of any of clauses 53 to 54, wherein the at least one processor is further configured to: provision the UE with one or more rules associated with one or more criteria for autonomous SL Rx-Tx time difference measurement type selection at the UE.

Clause 56. The position estimation entity of any of clauses 53 to 55, wherein, the determined SL Rx-Tx time difference measurement type is the first SL Rx-Tx time difference measurement type, and for each of the one or more SL Rx-Tx time difference measurements in accordance with the first SL Rx-Tx time difference measurement type: the first PRS and the second PRS are SL-PRSs, or the first PRS is downlink PRS (DL-PRS) and the second PRS is SL-PRS, or the first PRS is SL-PRS and the second PRS is uplink (UL-PRS), or wherein, the determined SL Rx-Tx time difference measurement type is the second SL Rx-Tx time difference measurement type, and, for each of the one or more SL Rx-Tx time difference measurements in accordance with the second SL Rx-Tx time difference measurement type: the first PRS is SL-PRS and the third subframe is configured for SL, or the first PRS is DL-PRS and the third subframe is configured for SL, or the first PRS is SL-PRS and the third subframe is configured for UL.

Clause 57. A user equipment (UE), comprising: means for transmitting a capability indication that indicates that the UE is capable of performing a first sidelink (SL) receive-transmit (Rx-Tx) time difference measurement type and a second SL Rx-Tx time difference measurement type to a position estimation entity, wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe; means for receiving a measurement request for the UE to perform one or more SL Rx-Tx time difference measurements, and means for determining whether to perform the one or more SL Rx-Tx time difference measurements in accordance with the first SL Rx-Tx time difference measurement type or the second SL Rx-Tx time difference measurement type, wherein the determination is based on an explicit network-designated SL Rx-Tx time difference measurement type associated with the measurement request, or wherein the determination comprises an autonomous selection at the UE based on one or more rules associated with one or more criteria: means for performing the one or more SL Rx-Tx time difference measurements in accordance with the determined SL Rx-Tx time difference measurement type; and means for transmitting a measurement report comprising measurement information that is based on the one or more SL Rx-Tx time difference measurements to a position estimation entity.

Clause 58. The UE of clause 57, wherein the determination is based on the explicit network-designated SL Rx-Tx time difference measurement type associated with the measurement request.

Clause 59. The UE of any of clauses 57 to 58, wherein the one or more rules comprise: means for selecting a default SL Rx-Tx time difference measurement type if the measurement request is not associated with the explicit network-designated SL Rx-Tx time difference measurement type.

Clause 60. The UE of any of clauses 57 to 59, wherein the one or more criteria comprise a time difference between the first subframe and the second subframe.

Clause 61. The UE of clause 60, wherein the one or more rules comprise: means for selecting the first SL Rx-Tx time difference measurement type if the time difference exceeds a time difference threshold, and means for selecting the second SL Rx-Tx time difference measurement type if the time difference does not exceed the time difference threshold.

Clause 62. The UE of any of clauses 57 to 61, wherein the one or more criteria comprise UE mobility.

Clause 63. The UE of clause 62, wherein the one or more rules comprise: means for selecting the first SL Rx-Tx time difference measurement type if the UE mobility exceeds a UE mobility threshold, and means for selecting the second SL Rx-Tx time difference measurement type if the UE mobility does not the UE mobility threshold.

Clause 64. The UE of any of clauses 57 to 63, wherein the one or more criteria comprise a reference signal received power (RSRP) change.

Clause 65. The UE of clause 64, wherein the one or more rules comprise: means for selecting the first SL Rx-Tx time difference measurement type if the RSRP change exceeds a RSRP change threshold, and means for selecting the second SL Rx-Tx time difference measurement type if the RSRP change does not exceed the RSRP change threshold.

Clause 66. The UE of any of clauses 57 to 65, wherein the one or more criteria comprise a timing change parameter.

Clause 67. The UE of clause 66, wherein the one or more rules comprise: means for selecting the first SL Rx-Tx time difference measurement type if a timing change is performed, and means for selecting the second SL Rx-Tx time difference measurement type if the timing change is not performed.

Clause 68. The UE of any of clauses 66 to 67, wherein the timing change parameter is associated with timing changes in response to a timing advance (TA) command, an autonomous adjustment by the UE, or a combination thereof.

Clause 69. The UE of any of clauses 57 to 68, wherein the one or more criteria comprises a measurement value difference between (i) the UE received timing associated with the first subframe comprising the first PRS from the another device and (iii) the second UE transmit timing of the third subframe.

Clause 70. The UE of clause 69, wherein the one or more rules comprise: means for selecting the first SL Rx-Tx time difference measurement type if the measurement value difference exceeds a measurement value difference threshold, and means for selecting the second SL Rx-Tx time difference measurement type if the measurement value difference does not exceed the measurement value difference threshold.

Clause 71. The UE of any of clauses 57 to 70, wherein the one or more criteria, the one or more rules, or both, comprise at least one criterion, at least one rule, or both, that is: means for -defined, or means for-configured before a positioning session of the UE is initiated, or configured for the positioning session by the positioning estimation entity, a network component or another UE, or any combination thereof.

Clause 72. The UE of any of clauses 57 to 71, wherein the determined SL Rx-Tx time difference measurement type is associated with a resource pool, or wherein the determined SL Rx-Tx time difference measurement type is associated with a SL-PRS resource or SL-PRS resource set.

Clause 73. The UE of any of clauses 57 to 72, wherein the determination is made autonomously at the UE based on the one or more rules associated with the one or more criteria, and wherein the measurement report comprises an indication of the determined SL Rx-Tx time difference measurement type.

Clause 74. The UE of clause 73, wherein the indication of the of the determined SL Rx-Tx time difference measurement type is based on whether the measurement information comprises a timestamp associated with UE transmit timing.

Clause 75. The UE of clause 74, wherein the indication indicates the first SL Rx-Tx time difference measurement type if the measurement information comprises the timestamp, and wherein the indication indicates the second SL Rx-Tx time difference measurement type if the measurement information does not comprise the timestamp.

Clause 76. The UE of any of clauses 57 to 75, wherein all measurement information in the measurement report is associated with the determined SL Rx-Tx time difference measurement type, or wherein the measurement report further comprises additional measurement information that is based on at least one SL Rx-Tx time difference measurement in accordance with a respective SL Rx-Tx time difference measurement type other than the determined SL Rx-Tx time difference measurement type.

Clause 77. The UE of any of clauses 57 to 76, wherein the determined SL Rx-Tx time difference measurement type is the first SL Rx-Tx time difference measurement type.

Clause 78. The UE of clause 77, wherein, for each of the one or more SL Rx-Tx time difference measurements in accordance with the first SL Rx-Tx time difference measurement type: the first PRS and the second PRS are SL-PRSs, or the first PRS is downlink PRS (DL-PRS) and the second PRS is SL-PRS, or the first PRS is SL-PRS and the second PRS is uplink (UL-PRS).

Clause 79. The UE of any of clauses 57 to 78, wherein the determined SL Rx-Tx time difference measurement type is the second SL Rx-Tx time difference measurement type.

Clause 80. The UE of any of clauses 77 to 79, wherein, for each of the one or more SL Rx-Tx time difference measurements in accordance with the second SL Rx-Tx time difference measurement type: the first PRS is SL-PRS and the third subframe is configured for SL, or the first PRS is downlink PRS (DL-PRS) and the third subframe is configured for SL, or the first PRS is SL-PRS and the third subframe is configured for uplink (UL).

Clause 81. A position estimation entity, comprising: means for receiving a capability indication that indicates that a user equipment (UE) is capable of performing a first sidelink (SL) receive-transmit (Rx-Tx) time difference measurement type and a second SL Rx-Tx time difference measurement type to a position estimation entity, wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe; means for transmitting a measurement request for the UE to perform one or more SL Rx-Tx time difference measurements; means for receiving a measurement report comprising measurement information that is based on one or more SL Rx-Tx time difference measurements; and means for determining whether the measurement information is based on the first SL Rx-Tx time difference measurement type or the second SL Rx-Tx time difference measurement type.

Clause 82. The position estimation entity of clause 81, wherein the determination is based on which of the first SL Rx-Tx time difference measurement type or the second SL Rx-Tx time difference measurement type is explicitly designated by the position estimation entity to the UE, or wherein the determination is based on an indication in the measurement report.

Clause 83. The position estimation entity of any of clauses 81 to 82, further comprising: means for provisioning the UE with one or more rules associated with one or more criteria for autonomous SL Rx-Tx time difference measurement type selection at the UE.

Clause 84. The position estimation entity of any of clauses 81 to 83, wherein, the determined SL Rx-Tx time difference measurement type is the first SL Rx-Tx time difference measurement type, and for each of the one or more SL Rx-Tx time difference measurements in accordance with the first SL Rx-Tx time difference measurement type: the first PRS and the second PRS are SL-PRSs, or the first PRS is downlink PRS (DL-PRS) and the second PRS is SL-PRS, or the first PRS is SL-PRS and the second PRS is uplink (UL-PRS), or wherein, the determined SL Rx-Tx time difference measurement type is the second SL Rx-Tx time difference measurement type, and, for each of the one or more SL Rx-Tx time difference measurements in accordance with the second SL Rx-Tx time difference measurement type: the first PRS is SL-PRS and the third subframe is configured for SL, or the first PRS is DL-PRS and the third subframe is configured for SL, or the first PRS is SL-PRS and the third subframe is configured for UL.

Clause 85. A non-transitory computer-readable medium storing computer-executable instructions that, when executed by a user equipment (UE), cause the UE to: transmit a capability indication that indicates that the UE is capable of performing a first sidelink (SL) receive-transmit (Rx-Tx) time difference measurement type and a second SL Rx-Tx time difference measurement type to a position estimation entity, wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe; receive a measurement request for the UE to perform one or more SL Rx-Tx time difference measurements; and determine whether to perform the one or more SL Rx-Tx time difference measurements in accordance with the first SL Rx-Tx time difference measurement type or the second SL Rx-Tx time difference measurement type, wherein the determination is based on an explicit network-designated SL Rx-Tx time difference measurement type associated with the measurement request, or wherein the determination comprises an autonomous selection at the UE based on one or more rules associated with one or more criteria; perform the one or more SL Rx-Tx time difference measurements in accordance with the determined SL Rx-Tx time difference measurement type; and transmit a measurement report comprising measurement information that is based on the one or more SL Rx-Tx time difference measurements to a position estimation entity.

Clause 86. The non-transitory computer-readable medium of clause 85, wherein the determination is based on the explicit network-designated SL Rx-Tx time difference measurement type associated with the measurement request.

Clause 87. The non-transitory computer-readable medium of any of clauses 85 to 86, wherein the one or more rules comprise: select a default SL Rx-Tx time difference measurement type if the measurement request is not associated with the explicit network-designated SL Rx-Tx time difference measurement type.

Clause 88. The non-transitory computer-readable medium of any of clauses 85 to 87, wherein the one or more criteria comprise a time difference between the first subframe and the second subframe.

Clause 89. The non-transitory computer-readable medium of clause 88, wherein the one or more rules comprise: select the first SL Rx-Tx time difference measurement type if the time difference exceeds a time difference threshold, and select the second SL Rx-Tx time difference measurement type if the time difference does not exceed the time difference threshold.

Clause 90. The non-transitory computer-readable medium of any of clauses 85 to 89, wherein the one or more criteria comprise UE mobility.

Clause 91. The non-transitory computer-readable medium of clause 90, wherein the one or more rules comprise: select the first SL Rx-Tx time difference measurement type if the UE mobility exceeds a UE mobility threshold, and select the second SL Rx-Tx time difference measurement type if the UE mobility does not the UE mobility threshold.

Clause 92. The non-transitory computer-readable medium of any of clauses 85 to 91, wherein the one or more criteria comprise a reference signal received power (RSRP) change.

Clause 93. The non-transitory computer-readable medium of clause 92, wherein the one or more rules comprise: select the first SL Rx-Tx time difference measurement type if the RSRP change exceeds a RSRP change threshold, and select the second SL Rx-Tx time difference measurement type if the RSRP change does not exceed the RSRP change threshold.

Clause 94. The non-transitory computer-readable medium of any of clauses 85 to 93, wherein the one or more criteria comprise a timing change parameter.

Clause 95. The non-transitory computer-readable medium of clause 94, wherein the one or more rules comprise: select the first SL Rx-Tx time difference measurement type if a timing change is performed, and select the second SL Rx-Tx time difference measurement type if the timing change is not performed.

Clause 96. The non-transitory computer-readable medium of any of clauses 94 to 95, wherein the timing change parameter is associated with timing changes in response to a timing advance (TA) command, an autonomous adjustment by the UE, or a combination thereof.

Clause 97. The non-transitory computer-readable medium of any of clauses 85 to 96, wherein the one or more criteria comprises a measurement value difference between (i) the UE received timing associated with the first subframe comprising the first PRS from the another device and (iii) the second UE transmit timing of the third subframe.

Clause 98. The non-transitory computer-readable medium of clause 97, wherein the one or more rules comprise: select the first SL Rx-Tx time difference measurement type if the measurement value difference exceeds a measurement value difference threshold, and select the second SL Rx-Tx time difference measurement type if the measurement value difference does not exceed the measurement value difference threshold.

Clause 99. The non-transitory computer-readable medium of any of clauses 85 to 98, wherein the one or more criteria, the one or more rules, or both, comprise at least one criterion, at least one rule, or both, that is: -defined, or -configured before a positioning session of the UE is initiated, or configured for the positioning session by the positioning estimation entity, a network component or another UE, or any combination thereof.

Clause 100. The non-transitory computer-readable medium of any of clauses 85 to 99, wherein the determined SL Rx-Tx time difference measurement type is associated with a resource pool, or wherein the determined SL Rx-Tx time difference measurement type is associated with a SL-PRS resource or SL-PRS resource set.

Clause 101. The non-transitory computer-readable medium of any of clauses 85 to 100, wherein the determination is made autonomously at the UE based on the one or more rules associated with the one or more criteria, and wherein the measurement report comprises an indication of the determined SL Rx-Tx time difference measurement type.

Clause 102. The non-transitory computer-readable medium of clause 101, wherein the indication of the of the determined SL Rx-Tx time difference measurement type is based on whether the measurement information comprises a timestamp associated with UE transmit timing.

Clause 103. The non-transitory computer-readable medium of clause 102, wherein the indication indicates the first SL Rx-Tx time difference measurement type if the measurement information comprises the timestamp, and wherein the indication indicates the second SL Rx-Tx time difference measurement type if the measurement information does not comprise the timestamp.

Clause 104. The non-transitory computer-readable medium of any of clauses 85 to 103, wherein all measurement information in the measurement report is associated with the determined SL Rx-Tx time difference measurement type, or wherein the measurement report further comprises additional measurement information that is based on at least one SL Rx-Tx time difference measurement in accordance with a respective SL Rx-Tx time difference measurement type other than the determined SL Rx-Tx time difference measurement type.

Clause 105. The non-transitory computer-readable medium of any of clauses 85 to 104, wherein the determined SL Rx-Tx time difference measurement type is the first SL Rx-Tx time difference measurement type.

Clause 106. The non-transitory computer-readable medium of clause 105, wherein, for each of the one or more SL Rx-Tx time difference measurements in accordance with the first SL Rx-Tx time difference measurement type: the first PRS and the second PRS are SL-PRSs, or the first PRS is downlink PRS (DL-PRS) and the second PRS is SL-PRS, or the first PRS is SL-PRS and the second PRS is uplink (UL-PRS).

Clause 107. The non-transitory computer-readable medium of any of clauses 85 to 106, wherein the determined SL Rx-Tx time difference measurement type is the second SL Rx-Tx time difference measurement type.

Clause 108. The non-transitory computer-readable medium of any of clauses 105 to 107, wherein, for each of the one or more SL Rx-Tx time difference measurements in accordance with the second SL Rx-Tx time difference measurement type: the first PRS is SL-PRS and the third subframe is configured for SL, or the first PRS is downlink PRS (DL-PRS) and the third subframe is configured for SL, or the first PRS is SL-PRS and the third subframe is configured for uplink (UL).

Clause 109. A non-transitory computer-readable medium storing computer-executable instructions that, when executed by a position estimation entity, cause the position estimation entity to: receive a capability indication that indicates that a user equipment (UE) is capable of performing a first sidelink (SL) receive-transmit (Rx-Tx) time difference measurement type and a second SL Rx-Tx time difference measurement type to a position estimation entity, wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe: transmit a measurement request for the UE to perform one or more SL Rx-Tx time difference measurements, receive a measurement report comprising measurement information that is based on one or more SL Rx-Tx time difference measurements; and determine whether the measurement information is based on the first SL Rx-Tx time difference measurement type or the second SL Rx-Tx time difference measurement type.

Clause 110. The non-transitory computer-readable medium of clause 109, wherein the determination is based on which of the first SL Rx-Tx time difference measurement type or the second SL Rx-Tx time difference measurement type is explicitly designated by the position estimation entity to the UE, or wherein the determination is based on an indication in the measurement report.

Clause 111. The non-transitory computer-readable medium of any of clauses 109 to 110, further comprising computer-executable instructions that, when executed by the position estimation entity, cause the position estimation entity to: provision the UE with one or more rules associated with one or more criteria for autonomous SL Rx-Tx time difference measurement type selection at the UE.

Clause 112. The non-transitory computer-readable medium of any of clauses 109 to 111, wherein, the determined SL Rx-Tx time difference measurement type is the first SL Rx-Tx time difference measurement type, and for each of the one or more SL Rx-Tx time difference measurements in accordance with the first SL Rx-Tx time difference measurement type: the first PRS and the second PRS are SL-PRSs, or the first PRS is downlink PRS (DL-PRS) and the second PRS is SL-PRS, or the first PRS is SL-PRS and the second PRS is uplink (UL-PRS), or wherein, the determined SL Rx-Tx time difference measurement type is the second SL Rx-Tx time difference measurement type, and, for each of the one or more SL Rx-Tx time difference measurements in accordance with the second SL Rx-Tx time difference measurement type: the first PRS is SL-PRS and the third subframe is configured for SL, or the first PRS is DL-PRS and the third subframe is configured for SL, or the first PRS is SL-PRS and the third subframe is configured for UL.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of operating a user equipment (UE), comprising:
transmitting a capability indication that indicates that the UE is capable of performing a first sidelink (SL) receive-transmit (Rx-Tx) time difference measurement type and a second SL Rx-Tx time difference measurement type to a position estimation entity,
wherein the first SL Rx-Tx time difference measurement type is based on a first time difference between (i) a UE received timing associated with a first subframe comprising a first positioning reference signal (PRS) from another device, and (ii) a first UE transmit timing of a second subframe comprising a second PRS transmitted by the UE, and
wherein the second SL Rx-Tx time difference measurement type is based on a second time difference between (i) the UE received timing associated with the first subframe comprising the first PRS from the another device, and (iii) a second UE transmit timing of a third subframe that is subsequent to and closest in time to the first subframe;
receiving a measurement request for the UE to perform one or more SL Rx-Tx time difference measurements; and
determining whether to perform the one or more SL Rx-Tx time difference measurements in accordance with the first SL Rx-Tx time difference measurement type or the second SL Rx-Tx time difference measurement type,
wherein the determination is based on an explicit network-designated SL Rx-Tx time difference measurement type associated with the measurement request, or
wherein the determination comprises an autonomous selection at the UE based on one or more rules associated with one or more criteria; performing the one or more SL Rx-Tx time difference measurements in accordance with the determined SL Rx-Tx time difference measurement type; and
transmitting a measurement report comprising measurement information that is based on the one or more SL Rx-Tx time difference measurements to a position estimation entity.

2. The method of claim 1, wherein the determination is based on the explicit network-designated SL Rx-Tx time difference measurement type associated with the measurement request.

3. The method of claim 1, wherein the one or more rules comprise: selecting a default SL Rx-Tx time difference measurement type if the measurement request is not associated with the explicit network-designated SL Rx-Tx time difference measurement type.

4. The method of claim 1, wherein the one or more criteria comprise a time difference between the first subframe and the second subframe.

5. The method of claim 4, wherein the one or more rules comprise: selecting the first SL Rx-Tx time difference measurement type if the time difference exceeds a time difference threshold, and
selecting the second SL Rx-Tx time difference measurement type if the time difference does not exceed the time difference threshold.

6. The method of claim 1, wherein the one or more criteria comprise UE mobility.

7. The method of claim 6, wherein the one or more rules comprise:
selecting the first SL Rx-Tx time difference measurement type if the UE mobility exceeds a UE mobility threshold, and
selecting the second SL Rx-Tx time difference measurement type if the UE mobility does not the UE mobility threshold.

8. The method of claim 1, wherein the one or more criteria comprise a reference signal received power (RSRP) change.

9. The method of claim 8, wherein the one or more rules comprise:
selecting the first SL Rx-Tx time difference measurement type if the RSRP change exceeds a RSRP change threshold, and
selecting the second SL Rx-Tx time difference measurement type if the RSRP change does not exceed the RSRP change threshold.

10. The method of claim 1, wherein the one or more criteria comprise a timing change parameter.

11. The method of claim 10, wherein the one or more rules comprise:
selecting the first SL Rx-Tx time difference measurement type if a timing change is performed, and
selecting the second SL Rx-Tx time difference measurement type if the timing change is not performed.

12. The method of claim 10, wherein the timing change parameter is associated with timing changes in response to a timing advance (TA) command, an autonomous adjustment by the UE, or a combination thereof.

13. The method of claim 1, wherein the one or more criteria comprises a measurement value difference between (i) the UE received timing associated with the first subframe comprising the first PRS from the another device and (iii) the second UE transmit timing of the third subframe.

14. The method of claim 13, wherein the one or more rules comprise:
selecting the first SL Rx-Tx time difference measurement type if the measurement value difference exceeds a measurement value difference threshold, and
selecting the second SL Rx-Tx time difference measurement type if the measurement value difference does not exceed the measurement value difference threshold.

15. The method of claim 1, wherein the one or more criteria, the one or more rules, or both, comprise at least one criterion, at least one rule, or both, that is:
pre-defined, or
pre-configured before a positioning session of the UE is initiated, or
configured for the positioning session by the positioning estimation entity, a network component or another UE, or
any combination thereof.

16. The method of claim 1,
wherein the determined SL Rx-Tx time difference measurement type is associated with a resource pool, or
wherein the determined SL Rx-Tx time difference measurement type is associated with a SL-PRS resource or SL-PRS resource set.

17. The method of claim 1,
wherein the determination is made autonomously at the UE based on the one or more rules associated with the one or more criteria, and
wherein the measurement report comprises an indication of the determined SL Rx-Tx time difference measurement type.

18. The method of claim 17, wherein the indication of the of the determined SL Rx-Tx time difference measurement type is based on whether the measurement information comprises a timestamp associated with UE transmit timing.

19. The method of claim 18,
wherein the indication indicates the first SL Rx-Tx time difference measurement type if the measurement information comprises the timestamp, and
wherein the indication indicates the second SL Rx-Tx time difference measurement type if the measurement information does not comprise the timestamp.

20. The method of claim 1,
wherein all measurement information in the measurement report is associated with the determined SL Rx-Tx time difference measurement type, or
wherein the measurement report further comprises additional measurement information that is based on at least one SL Rx-Tx time difference measurement in accordance with a respective SL Rx-Tx time difference measurement type other than the determined SL Rx-Tx time difference measurement type.

21.-30. (canceled)
